(19) United States
(12) Patent Application Publication
(10) Pub. No.: US 2025/0111775 A1
(43) Pub. Date: Apr. 3, 2025

(54) SYSTEM AND METHOD FOR SELECTING COOPERATIVE ACTION TO MITIGATE DISTURBANCES IN TRAFFIC

(71) Applicant: TOYOTA MOTOR ENGINEERING & MANUFACTURING NORTH AMERICA, INC., Plano, TX (US)

(72) Inventors: SERGEI S. AVEDISOV, Mountain View, CA (US); YASHAR ZEIYNALI FARID, Mountain View, CA (US); HAO M. WANG, Mountain View, CA (US); KATHY JANG, Mountain View, CA (US); ONUR ALTINTAS, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, TOYOTA-SHI (JP)

(21) Appl. No.: 18/479,527

(22) Filed: Oct. 2, 2023

(51) Int. Cl. G08G 1/01; B60W 60/00; G08G 1/09

(52) U.S. Cl. CPC G08G 1/0145; B60W 60/001; G08G 1/0112; G08G 1/0125; G08G 1/0141; G08G 1/093; B60W 2554/406; B60W 2556/65

(57) ABSTRACT

A system and methods are provided for implementing mitigation action selection, which utilizes a cooperative approach that recognizes how many other connected vehicles are in the vicinity and considers other factors for determining which control action to undertake for congestion mitigation. Various parameters in combination with traffic models are used to evaluate the susceptibility of each lane to propagation of disturbances. For example, a connected vehicle may first request a lane change, and an impact of that lane change on traffic is analyzed. If feasible, the lane change and define an optimal control action to mitigate any disturbance on traffic. If the impact is considered significant, then the lane change request may be denied. Additionally, a learning approach can be used to reinforcement learning model to perform the decision-making process. Accordingly, an optimal control action that lessens the effect of disturbances on traffic congestion can be determined for vehicles.

### TECHNICAL FIELD

The present disclosure generally relates to vehicle communication and vehicle navigation and/or computer-controlled driving technology. In particular, data from a plurality of vehicles having communication capabilities can be used in determining actions for vehicles to mitigate traffic congestion.

### DESCRIPTION OF RELATED ART

Traffic detection generally involves devices or systems that have the capability to detect the presence or movement of vehicles. These devices can then relay the information which is analyzed, typically by centralized servers or computational nodes, to aide in detecting real-time traffic or observing traffic patterns over time. Various types of existing traffic detection mechanisms can include: in-roadway sensors that sit on and/or under the surface (e.g., on pavement, on the surface of the road, etc.) to detect traffic-flow by detecting pressure changes that occur on the road surface; over roadway sensors (e.g., ultrasonic and passive infrared sensors) that sit above the road, and are often installed on the roadway or alongside the road, closest to vehicle movement on roads. Some common types of over roadway sensors include navigation systems, which typically include application platforms, to collect real-time information (e.g., vehicle speed, traffic conditions, and road structures) from sensors implemented on and/or near the vehicle to remotely located centralized systems to detect the presence of traffic and recognize traffic patterns.

In many cases, traffic detection serves as the basis for handling various other operational tasks of the vehicles. For example, if a vehicle is approaching a route where traffic congestion is detected, the vehicle may be alerted to slow down and/or rerouted. Overall, traffic detection and management of roadways is important, as ever-increasing rates of traffic issues across roads today is becoming a challenge. Using mechanisms such as traffic detection systems can be crucial in solving such problems, and can allow for drivers and/or vehicles to make the right adjustments to make congestion easy to manage and reduce collisions, injuries, and other potential hazards.

### BRIEF SUMMARY OF THE DISCLOSURE

In accordance with embodiments of the disclosed technology, a system for traffic congestion mitigation is implemented. The system may comprise a processor device analyzing data associated with a driving environment of a vehicle. The processor can select a mitigative action for the vehicle in response to a traffic disturbance present in the driving environment based on analyzing the data. The data may include messages communicated by a plurality of communicatively connected vehicles in the vicinity of the driving environment. In addition, the system can include a controller device executing autonomous actions to maneuver the vehicle based on the selected mitigative action.

In accordance with embodiments of the disclosed technology, a non-transitory computer readable medium comprising instructions, that when read by a processor, cause the processor to perform a series of actions implementing traffic congestion mitigation. The actions can include analyzing data associated with a driving environment of a vehicle. The data comprises messages communicated by a plurality of communicatively connected vehicles in the vicinity of the driving environment. The actions can also include selecting a mitigative action for the vehicle in response to a traffic disturbance included in the driving environment based on analyzing the data, and executing autonomous actions to maneuver the vehicle based on the selected mitigative action.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example road environment including a vehicle implementing a mitigative action selection system, in accordance with an embodiment of the technology disclosed herein.

FIG. 2 is a block diagram representing an example architecture of the mitigative action selection system shown in FIG. 1, in accordance with an embodiment of the technology disclosed herein.

FIG. 3 is a flow diagram of an example method implementing simulation based mitigative action selection, in accordance with an embodiment of the technology disclosed herein.

FIG. 4 is a flow diagram of an example method implementing training a model for a learning based mitigative action selection process, in accordance with an embodiment of the technology disclosed herein.

FIG. 5 is a conceptual diagram of the example method for training a model for a learning based mitigative action selection process shown in FIG. 4, in accordance with an embodiment of the technology disclosed herein.

FIG. 6 is a flow diagram of an example method implementing learning based mitigative action selection, in accordance with an embodiment of the technology disclosed herein.

FIGS. 7A-7B show an example road environment for implementing mitigative action selection based on the particular environment, in accordance with an embodiment of the technology disclosed herein.

FIGS. 8A-8B show another example road environment for implementing mitigative action selection based on the particular environment, in accordance with an embodiment of the technology disclosed herein.

FIGS. 9A-9B show another example road environment for implementing mitigative action selection based on the particular environment, in accordance with an embodiment of the technology disclosed herein.

FIGS. 10A-10D show yet another example road environment for implementing mitigative action selection based on the particular environment, in accordance with an embodiment of the technology disclosed herein.

FIGS. 11A-11C show yet another example road environment for implementing mitigative action selection based on the particular environment, in accordance with an embodiment of the technology disclosed herein.

FIGS. 12A-12B show yet another example road environment for implementing mitigative action selection based on the particular environment, in accordance with an embodiment of the technology disclosed herein.

FIG. 13 depicts an example network architecture of an in-vehicle mitigative action selection system, in accordance with an embodiment of the technology disclosed herein.

FIG. 14 is a schematic representation of an example vehicle with which embodiments of the mitigative action selection system disclosed herein may be implemented.

FIG. 15 is an example computing component that may be used to implement various features of embodiments described in the present disclosure.

The figures are not exhaustive and do not limit the present disclosure to the precise form disclosed.

### DETAILED DESCRIPTION

Some vehicles include computer-controlled operational modes, such as vehicles having adaptive cruise control mode and automated vehicles, in which a computing system is used to navigate and/or maneuver the vehicle along a travel route. During adaptive cruise control operation, for example, the driving speed of the vehicle can be limited by various factors, such as traffic congestion (e.g., preceding vehicles travelling at slower speeds, preceding vehicles stopped). In another example, many existing vehicle navigation systems alert a driver of the presence of traffic along an intended route, in order to provide traffic related information that may be pertinent to driving, such as alternate routes, time delay estimations, or automated driving actions.

Furthermore, vehicles can include advancements and innovations in safety that help prevent crashes, collisions, and other dangerous conditions in order to protect drivers and passengers. For example, some vehicles are equipped with technology, such as computer-controlled vehicle safety systems and collision avoidance systems, that are designed to support driver awareness, decision making and vehicle operation over a wide range of speeds. Thus, the mechanisms employed by vehicles to detect traffic congestion should have relatively high accuracy, especially when utilized with computer-controlled operational modes (e.g., detecting traffic directly impacts operation of the vehicle and/or collision avoidance systems).

However, some currently-employed mechanisms for traffic detection, such as navigation systems, rely on drivers sharing real-time information (e.g., vehicle speed, traffic conditions, and road structures) to remotely located cloud computing systems and/or edge computing systems. Thus, the overall performance and accuracy of these mechanisms for detecting traffic are dependent upon the reliability and strength of communication between the vehicle and the remote cloud and/or edge computers. For example, in instances where a vehicle's communication to the cloud is weak (or otherwise interrupted) these conventional mechanisms may be incapable of properly collecting the information needed for analysis, and in turn would not be able to provide the driver with accurate traffic detection and other related information (e.g., the most optimal route to their destination) used to efficiently and safely navigate and/or maneuver the vehicle on the road. For these reasons, it can be advantageous to develop cooperative traffic congestion mitigation mechanisms that leverage communication capabilities directly between vehicles as disclosed herein. In this way, connected vehicles may act as communication points (as opposed to having to communicate with remote cloud computing and/or edge computing systems). In particular, the disclosed mitigation action selection system utilizes distinct processes that leverage vehicular connectivity to communicate with other vehicles within the vicinity and consider various traffic-related factors to determine an appropriate control action (e.g., lane change or decelerate) to mitigate traffic congestion.

Furthermore, in mixed traffic environments, where communicatively connected vehicles are traveling along roadways with unconnected vehicles (e.g., vehicles without communication capabilities) mixed in the traffic, it may be even more challenging to manage traffic congestion. For instance, a vehicle's ability to manage congestion may depend on several factors that cannot be communicated by each of the vehicles in the mixed traffic environment, such as the topology and market penetration of connected vehicles, the road configuration (e.g., number of lanes are present), the densities in these lanes, the physical parameters of the vehicles, and other traffic-related conditions. Although there are certain control actions that a vehicle may take to mitigate traffic congestion, including making a lane change or decelerating smoothly to damp out oscillations, in these types of mixed traffic scenarios it might not be clear which strategy and/or set of control actions may be the most optimal response.

In order to address these challenges, the disclosed mitigation action selection system and techniques are configured to utilize a cooperative approach that recognizes how many other connected vehicles are in the vicinity, in addition to considering the multiple other factors that are pertinent to determining which control action to undertake for congestion mitigation, such as a magnitude of a detected disturbance, a density of vehicles in the lanes, safety conditions, and the like. In some embodiments, the system uses parameters in combination with traffic models to evaluate the susceptibility of each lane to propagation of disturbances while further considering the number of cooperating connected vehicles. In particular, a connected vehicle may first request a lane change from which the system analyzes an impact of the lane change on traffic. If feasible, the connected vehicles can approve the lane change while defining an optimal control action for one or more connected vehicles to mitigate any disturbance on traffic. If the impact is considered to be too significant, then the system can deny the lane change request. Additionally, in some embodiments, the system may implement a learning approach that implements a reinforcement learning model to perform the decision-making process. Accordingly, the system accepts various parameters as inputs and functions to determine an optimal control action that lessens the effect of disturbances on traffic congestion.

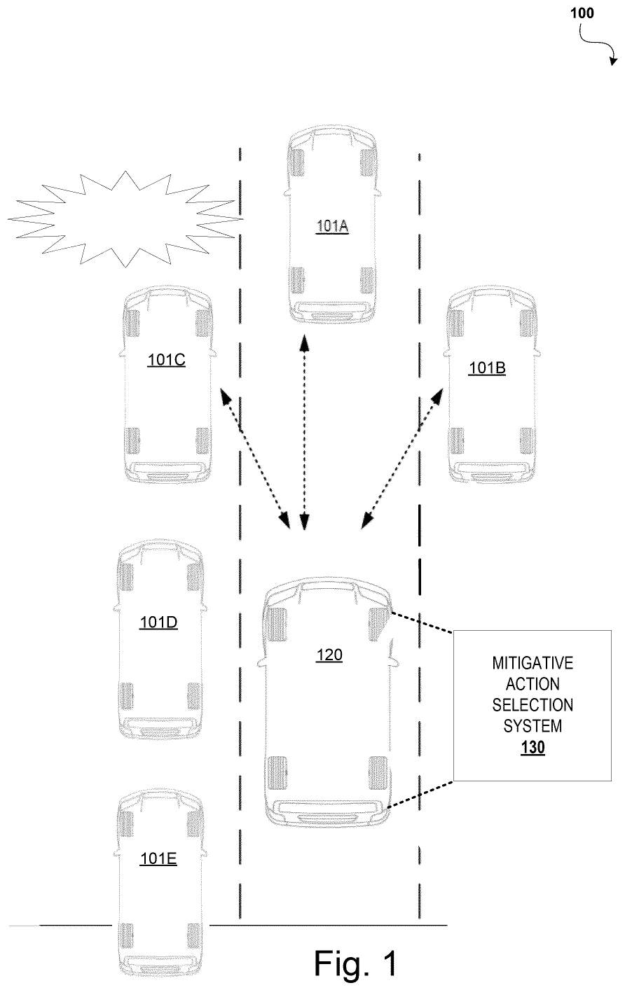

Referring now to FIG. 1, an example of a road environment 100 is depicted, which includes a vehicle 120 that is configured to implement the mitigative action selection system 130 and capabilities, as disclosed herein. FIG. 1 illustrates an example of a road environment, shown as a three-lane highway, which includes a plurality of vehicles 101A-101E traveling on the road. At least one of the plurality of vehicles, particularly vehicle 120, is configured to implement cooperative traffic mitigation as disclosed herein. In FIG. 1, vehicle 120 is depicted as being equipped with the mitigative action selection system 130.

FIG. 1 illustrates that while vehicle 120 is operational, for instance being driven on the freeway, the vehicle 120 may be traveling at a certain speed in a lane on the road. FIG. 1 also shows that while vehicle 120 is being driven, it is surrounded by a plurality of other vehicles 101A-101E in the adjacent lanes within its vicinity. This is a common road environment in several different real-life scenarios, for instance driving during rush hours, driving in densely populated areas (e.g., metropolitan areas), and the like. Further, as seen in FIG. 1, vehicle 120 is traveling directly behind vehicle 101A in the same lane, depicted as a middle land of the three-lane freeway.

For purposes of illustration, vehicle 101C, which is preceding the other vehicles 101D-101E on the highway, is approaching a traffic incident, such as a collision between two vehicles. This type of incident has a direct impact on traffic, for example causing other vehicles (not shown) ahead on the highway (especially in the same lane as vehicle 101C) to travel at a significantly reduced speed, or to become completely stopped. As a result, vehicle 101C is traveling at a slower rate of speed than the other vehicles in the vicinity (e.g., not in the same lane as the traffic incident), including vehicle 101A and vehicle 120 in the center lane, and vehicle 101B traveling in the right most lane.

Continuing with the example, it may be desirable for the driver of vehicle 101C to maneuver in a manner that avoids the traffic incident ahead in their lane and/or avoids having to significantly reduce their driving speed (or come to a complete stop). Furthermore, vehicle 101C can determine that other vehicles in the vicinity have communication capability (e.g., V2V connectivity) and thus can receive communication messages. For example, FIG. 1 illustrates vehicle 120 as having a V2V connection (shown as dotted line arrows) established with neighboring vehicles 101A, 101B, and 101C, which forms a type of vehicular network that enables communication between these vehicles. As alluded to above, the disclosed mitigative action selection techniques do not require all vehicles in an area to be communicatively connected or otherwise have wireless networking capabilities, and thus can be employed in mixed traffic environments which are more prevalent in real world applications.

As vehicle 101C intends to perform a mitigation maneuver, specifically a lane change in order to avoid the traffic incident ahead (e.g., occurring in the leftmost lane of the freeway), the vehicle 101C can send a request message (also referred to herein as a maneuver message) to vehicle 120, which is traveling in the adjacent lane and has a wireless connection with vehicle 101C. As seen in FIG. 1, there are other vehicles that are also driving in the center lane along with vehicle 120, particularly vehicle 101A. Consequently, there is potential that vehicle 120 moving to the center lane can cause disruption to the traffic currently traveling in the lane, for instance causing congestion in the center lane for vehicle 120 and any vehicles behind it in that lane. Because vehicle 101C's lane change will disturb vehicle 120 and could potentially lead to traffic congestion, vehicle 101C sends the request message to vehicle 120, having mitigation action selection capabilities, prior to performing any maneuver which allows vehicle 120 to apply its distinct processing functions to select optimal actions that mitigate this potential disturbance. In response to receiving the request message from vehicle 101C, vehicle 120 can perform the mitigation action selection techniques described in greater herein. For instance, vehicle 120 may employ the mitigative action selection system 130 and leverage its V2V communication connections between the other communication-capable vehicles 101A-101C in its vicinity on the road, in order to collect related data. Furthermore, the mitigative action selection system 130 can create a simulation and/or apply learning-based techniques to evaluate the effects of vehicle's 101C lane change on each of the lanes in the freeway, in order to ultimately determine the most optimal control action for maneuvering vehicle 101C in this scenario. In this example, based on the mitigative action selection techniques, vehicle 120 determines that the rightmost lane of the freeway has low traffic density, having only vehicle 101B travelling in the lane within their local vicinity. Subsequently, vehicle 120 can determine that to achieve optimal congestion mitigation it can also change lanes, moving to the right into its adjacent lane with this low traffic density (e.g., the rightmost of the freeway). That is, the mitigative action selection system 130 executes processing which considers different data and factors related to the driving environment, and selects cooperative mitigative actions, where cooperative mitigative actions are control actions that are taken by one or more vehicles to execute a coordinated maneuvering of these vehicles to mitigate the same traffic disturbance. In the example of FIG. 1, the cooperative mitigative actions involve vehicle 120 also changing lanes (to the right lane) to create a greater gap behind vehicle 101A. This frees up space in the center lane, allowing for vehicle 101C to then easily perform its mitigative action (e.g., lane change), moving from the leftmost lane to the center lane, and in a manner that mitigates congestion for the traffic in that lane (and the potential of that congestion permeating to cause more traffic congestion in the other lanes across the freeway for other vehicles). Subsequently, the ego vehicle 120 can perform one or more autonomous actions in order to execute its lane change maneuver, which was selected by the mitigative action selection system 130.

Accordingly, the vehicle 120 being equipped with the mitigative action selection system 130, utilizes data (e.g., sensor data) from the connected neighboring vehicles 101A-101C in order to detect the presence of traffic, and ultimately make a prediction about potential traffic congestion levels to select a control action for a vehicle and/or cooperative control actions for multiple vehicles that is most optimal with respect to mitigating traffic congestion and further avoiding dangerous incidents (e.g., collisions, crashes, and the like).

In some embodiments, the vehicle 120 utilizes one or more mitigative actions that are ultimately selected by the mitigative action selection system 130 as a trigger for other functions. The mitigative action selection system 130 can generate notifications, warnings, alerts, and other visual, audio, and tactile outputs that enable drivers to make safer actions in operating the vehicle, and provide additional reaction time for unexpected changes on the road. Furthermore, the mitigative action selection system 130 can generate messages, notifications, warnings, alerts, for operators of other connected vehicles that may be traveling on the road within its vicinity, such as vehicles in the section of the road where vehicle 120 is currently traveling (e.g., within range of the wireless communication technology). For instance, these messages transmitted from vehicle 120 to other connected vehicles may notify the respective vehicle of its selected control action (e.g., lane change, deceleration), and allow for anticipation of any cooperative maneuvers to be performed by other connected vehicles. In some implementations, the messages that are communicated to other connected vehicles further also effectuate automated (or semi-automated) maneuvers of these vehicles. Referring back to the example of FIG. 1, in the case where the mitigative action selection system 130 selects a lane change for vehicle 101C as an optimal control action to avoid traffic congestion, vehicle 120 may generate messages which are communicated back to vehicle 101C notifying it of the cooperative mitigative action (e.g., lane change maneuvering of vehicle 120), and notifying vehicle 101C of its corresponding control action, such as triggering an automated lane change maneuver for vehicle 101C. In another example, the mitigative action selection system 130 may generate notifications that inform other connected vehicles about any detected traffic congestion along the road, traffic incidents, hazards, and other changes in the traffic condition such that those drivers have additional time to revise their actions or routes accordingly.

Additionally, in response to the mitigative action selection system 130 selecting the appropriate control action(s), the selection data can be taken as output from the system 130 to further notify the driver and/or effectuate automated (or semi-automated) maneuvers of the vehicle 120 such that collisions, slowdowns, traffic congestion, and road closures are avoided. Referring back to example where the mitigative action selection system 130 selects a lane change for vehicle 120 as an optimal control action to avoid traffic congestion in the lane it is currently traveling, other components and/or systems of the vehicle 120 may generate alerts for the driver (e.g., indicating traffic), and the corresponding autonomous maneuvers (e.g., decreasing speed, changing directions, lane change, etc.) to automatically perform the mitigative action.

Although the example described with reference to FIG. 1 is a type of autonomous vehicle, the systems and methods described herein can be implemented in other types of vehicles including semi-autonomous vehicles, vehicles with automatic controls (e.g., dynamic cruise control), or other vehicles. Also, the vehicle 120 implementing the mitigative action selection system 130 described with reference to FIG. 1 is a type of hybrid electric vehicle (HEV). However, this is not intended to be limiting, and the disclosed embodiments can be implemented in other types of vehicles including gasoline- or diesel-powered vehicles, fuel-cell vehicles, electric vehicles, or other vehicles.

According to an embodiment, vehicles implementing the mitigative action selection system 130 (shown as ego vehicle 120) can be a semi-autonomous vehicle, such as a vehicle having assisted driving capabilities, which also implements the vehicular knowledge networking and improved knowledge cycle functions, as disclosed herein. “Semi-autonomous operational mode” means that a portion of the navigation and/or maneuvering of the vehicle 120 along a travel route is performed by one or more computing systems, and a portion of the navigation and/or maneuvering of the vehicle 120 along a travel route is performed by a human driver. One example of a semi-autonomous operational mode is when an adaptive cruise control system is activated. In such case, the speed of a vehicle 120 can be automatically adjusted to maintain a safe distance from a vehicle ahead based on data received from on-board sensors, but the vehicle 120 is otherwise operated manually by a human driver. Upon receiving a driver input to alter the speed of the vehicle (e.g., by depressing the brake pedal to reduce the speed of the vehicle), the speed of the vehicle is reduced. Thus, with vehicle 120 operating as a semi-autonomous vehicle, a response can be partially automated. In an example, the controller communicates a newly generated (or updated) control to the vehicle 120 operating as a semi-autonomous vehicle. The vehicle 120 can automatically perform some of the desired adjustments (e.g., accelerating) with no human driver interaction. Alternatively, the vehicle 120 may notify a driver that driver input is necessary or desired in response to a new (or updated) safety control.

Alternatively, or in addition to the above-described modes, vehicles implementing the disclosed mitigative action selection system 130 (shown as ego vehicle 120) can have one or more autonomous operational modes. As used herein, “autonomous vehicle” means a vehicle that is configured to operate in an autonomous operational mode. “Autonomous operational mode” means that one or more computing systems of the vehicle 120 are used to navigate and/or maneuver the vehicle along a travel route with a limited level of input from a human driver which varies with the operational mode. As such, vehicle 120 can have a plurality of autonomous operational modes, where each mode correspondingly responds to a controller, with a varied level of automated response. In some embodiments, the vehicle 120 can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle 120, responses can be highly, or fully, automated. For example, a controller can be configured to communicate controls so as to operate the vehicle 120 autonomously and safely. After the controller communicates a control to the vehicle 120 operating as an autonomous vehicle, the vehicle 120 can automatically perform the desired adjustments (e.g., accelerating or decelerating) with no human driver interaction. Accordingly, vehicle 120 can operate any of its components autonomously, such as an engine.

FIG. 1 depicts the subset of vehicles on the roadway that have wireless communication capabilities, namely vehicles 101A-101C and vehicle 120. In some embodiments, vehicles 101A-101C and vehicle 120 are also sensor-rich vehicles (SRVs) that are equipped with advanced vehicles sensors, described herein as ranging sensors (e.g., cameras, LIDAR, radar, ultrasonic sensors) and, in some cases, advanced computational resources. Particularly in the example of FIG. 1, vehicles 101A, 101B, 101C, and 120 are implemented as SRVs. Accordingly, as SRVs, vehicles 101A-101C and vehicle 120 are enabled to utilize these advances sensors to sense various conditions on the roadway, and obtain data that is pertinent to traffic detection, such as, but not limited to: vehicle identifiers; the presence of other vehicles; vehicle position; vehicle speed; vehicle movement; vehicle motion direction; road data; lane data; vehicle acceleration; other static and dynamic objects; image data; planned route data; generated HD local map; processed perception data; and the like. Another subset of the plurality of vehicles in the road environment can be legacy vehicles (LVs) that have limited sensor and/or communication capabilities in comparison to the SRVs. FIG. 1 depicts vehicle 101D and 101E as a LV in the mixed traffic environment 100. As described herein, LVs, such as vehicle 101D, may have some sensors that are capable of sensing and limited communication of more basic types of vehicle data, such as vehicle identifiers, vehicle location, vehicle speed, vehicle acceleration, and the like. For instance, LVs can include Global Positioning System (GPS) sensors, which can provide the basic location, velocity, and acceleration of the vehicle.

Additionally, FIG. 1 illustrates wireless connections between communicatively connected vehicles, shown in FIG. 1 as vehicles 101A-101C, and 120, within the same vicinity (e.g., within wireless network range) on the roadway. Due to this wireless connectivity, data can be communicated between the connected vehicles, where the data can include information such as sensor messages, maneuver messages, basic safety messages and the like. Sensor messages can include data collected by the vehicle sensors of SRVs and LVs, and other related data that may be obtained from sensors and/or devices on-board the vehicle. In some embodiments, sensor messages are implemented as a general class of wireless messages exchanged between road users and infrastructure that contains information about the objects detected in the surrounding environment. Examples could be the Sensor Data Sharing Messages standardized by SAE or the Collective Perception Messages standardized by ETSI. Maneuver messages, in some implementations, are a general class of wireless messages exchanged between road users and infrastructure that contains the future trajectory (or possible future trajectories) of the transmitting road user. Examples of such messages could be the Maneuver Coordination Message (MCM) undergoing standardization by ETSI or the Maneuver Sharing Coordination Message (MSCM) currently being standardized by SAE. Additionally, basic safety messages can be implemented as wireless messages transmitted between vehicles, where the transmitter sends its position, speed and other static/dynamic information. Basic safety messages type of message is standardized by SAE, and we do not claim it as a novelty of the invention.

As previously described, connected vehicles are configured to utilize types of wireless networking technology that are suitable for vehicles, which enables a vehicle to wirelessly communicate with other vehicles, infrastructure, and communication points. In the example of FIG. 1, vehicles 101A-101C and 120 are equipped with vehicle-to-vehicle (V2V) communication capabilities. Thus, vehicles 101A-101C and 120 utilize V2V communication ability to form a communication network (as the vehicles are within range for V2V-based wireless communication), and wirelessly exchange information, such as maneuver messages, sensor data (e.g., speed and position of surrounding vehicles), and the like. That is, in the road environment 100 of FIG. 1, V2V enables at least a subset of the vehicles traveling within the same general section of the freeway (e.g., vehicles 101A-101C, and 120) to be able to communicate with each other. Vehicle 120 can receive and analyze data that is communicated over the formed wireless communication network, and employ other vehicle components and/or systems, such as the mitigative action selection system 130, to help perform automated actions that avoid crashes, ease traffic congestion, and overall improve the road environment 100.

In some embodiments, the connected vehicles, namely vehicles 101A-101C, and 120, are configured to utilize other forms of wireless networking technology, such as vehicle-to-infrastructure (V2I) and/or vehicle-to-everything (V2X) capabilities. Accordingly, vehicles 101A-101C, and 120 can employ V2I and/or V2X communication to wireless exchange additional data between the vehicles and road infrastructure. Thus, in some cases, road environment 100 may include infrastructure components such as lane markings, road signs, and traffic lights which can wirelessly provide information to the vehicle, and vice versa. Consequently, the data communicated to/from connected vehicles can include additional data obtain from these infrastructure components in V2I and/or V2X communication, allowing the mitigative action selection system 130 to have a vast amounts real-time, information rich, data that is related to road safety, energy savings, and traffic efficiency on the roads in order to further enhance the accuracy and the overall performance of its traffic congestion mitigation functions. In some embodiments, the vehicle 120 is further configured to employ the bidirectional communication of V2I and/or V2X to also provide the roadside units, cloud/edge servers, and traffic monitoring centers, with notifications of traffic congestion that it has detected and mitigative maneuvers (e.g., control actions) to be performed, when required and/or requested from the infrastructure.

Particularly, vehicle 120 is shown to include a mitigative action selection system 130. The mitigative action selection system 130 can be implemented as a vehicle controller, computing hardware, software, firmware, or a combination thereof, which is programmed to select actions for vehicles to mitigate traffic congestion in accordance with the disclosed techniques. The mitigative action selection system 130 may be a standalone controller in some embodiments. Alternatively, the mitigative action selection system 130 may be implemented by configuring a main vehicle onboard processor or CPU. As previously described, vehicle 120 can obtain data from the other communicatively connected vehicles 101A-101C on the road, via wireless network connectivity. This data communicated from connected vehicles can be cooperatively fused and serve as input to the mitigative action selection system 130.

FIG. 1 illustrates an example system for implementing the disclosed mitigative action selection techniques, which leverages cooperative capabilities between communicatively connected vehicles to evaluate a traffic environment and determine maneuvers that may mitigate any traffic disturbances, including traffic congestion. By generating simulations and/or applying deep learning techniques that particularly aim to attenuate traffic disturbances (e.g., in a lane) as much as possible, the disclosed system selects optimal mitigative actions for vehicles to perform, including cooperative maneuvers, which realize serval advantages associated with reducing traffic congestion, such as improved safety, passenger comfort, and energy consumption. For example, the disclosed system can additionally consider surrogate safety metrics for each lane, such as the time-to-collision (TTC), in order to further enhance safety. To achieve enhanced passenger comfort, the disclosed system can additionally observe a magnitude of the largest accelerations observed by downstream vehicles, or the magnitude of jerk (time derivative of acceleration) to reduce the repetitive sudden stops that are often experienced in high traffic congestion, which can lead to discomfort and potential injury for passengers. In order to achieve enhanced energy consumption, the disclosed systems can further analyze energy-related metrics for the vehicles, like the energy per unit mass, or use a model for the brake specific fuel consumption (BSFC) when engine, transmission, and final drive parameters are known. Furthermore, by leveraging vehicle connectivity, the disclosed system can improve its accuracy and ability to mitigate disturbances by functioning cooperatively with other connected automated vehicles, and eliminates the overhead associated with computation edge and/or cloud and a fixed traffic monitoring center.

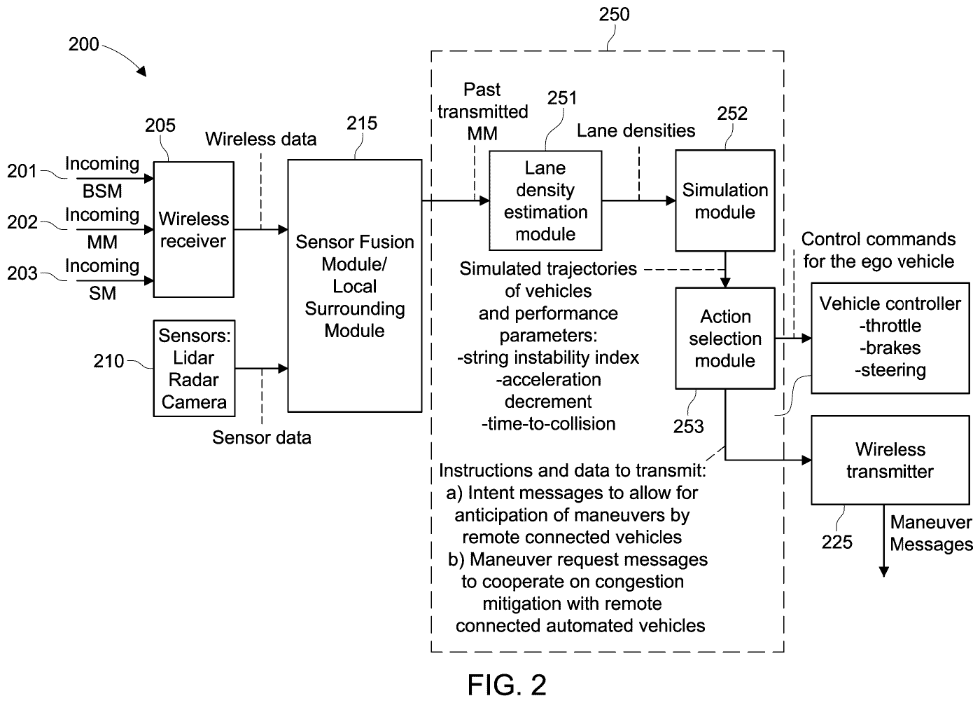

Referring now to FIG. 2, an example architecture for a mitigative action selection system 250 (also shown in FIG. 1) is depicted. In the architecture of FIG. 2, the mitigative action selection system 250 includes several internal components, including, but not limited to: a lane density estimation module 251; a simulation module 252; and an action selection module 253. FIG. 2 also illustrates other components, devices, and systems of a vehicle that may communicate with and/or cooperatively function with the mitigative action selection system 250. FIG. 2 shows an architecture having one or more vehicle components which are communicatively connected to the mitigative action selection system 250 including: a wireless receiver 205; vehicle sensors 210; a vehicle controller 220; and a wireless transmitter 225. Furthermore, FIG. 2 shows examples of various types of data that may be involved in the processing performed by the mitigative action selection system 250.

As previously described, a vehicle implementing the mitigative action selection system 250 can obtain data from the other communicatively connected vehicles sharing the road and within an appropriate range for wireless connectivity. This received data (e.g., obtained by the SRVs and the LVs in a wireless vehicular communication network) can be cooperatively fused and serve as input to the mitigative action selection system 250. In particular, FIG. 2 illustrates that data received by a vehicle implementing the mitigative action selection system 250 can include basic safety messages (BSM) 201, incoming maneuver messages (MM) 202, and sensor messages (SM) 203. As alluded to above, these messages 201-203 can be communicated wirelessly to the vehicle implanting the mitigative action selection system 250, from other vehicles in V2V communications. Thus, FIG. 2 depicts the messages 201-203 as being received as wireless data by the wireless receiver 205 of the vehicle. Also, FIG. 2 depicts that data can be obtained directly by the vehicle itself, which is shown as sensor data collected by various on-vehicle sensor systems, such as LIDAR, RADAR, and cameras. Further, in the example of FIG. 2, wireless data communicated to the vehicle and the sensor data obtained directly by the vehicle are transferred to a sensor fusion/local surrounding module 215. The sensor fusion/local surrounding module 215 is configured to cooperatively fuse the wireless data from the wireless receiver 205 and the sensor data from the vehicle's sensors 210 to allow this information to serve as input into the mitigative action selection system 250. Accordingly, FIG. 2 illustrates that data output from the sensor fusion/local surrounding module 215, including past maneuver messages, is subsequently input into the mitigative action selection system 250, particularly being received by the lane density estimation module 251.

The lane density estimation module 251 is configured to estimate the density of a current lane (e.g., the lane the ego vehicle is currently traveling in) and surrounding lanes. As referred to herein, lane density can be considered as a measurement of the net number of vehicles to enter and/or leave a single lane (i.e., the lane inflow) of a roadway. For example, sensor data from the vehicle's camera can be analyzed to indicate the presence and movement (e.g., direction, speed, etc.) of surrounding vehicles in nearby lanes. In some instances, the lane density estimation module 251 generates a density estimate for each lane in the road. For instance, in a six-lane freeway which accommodates six vehicles laterally/horizontally at a time, the lane density estimation module 251 can output six different lane density estimations, where each estimation corresponds to a respective lane. Alternatively, the lane density estimation module 251 may be configured to generate an estimate for a set number of lanes, for example determining a lane density estimation for the two lanes that are adjacent to the vehicle's current lane (e.g., having a higher probability of being impacted by a mitigative control action). According to an embodiment, the lane density estimation module 251 generates lane density estimations that are compared to a fundamental diagram which shows when disturbances can lead to traffic jams.

Further, FIG. 2 illustrates that the lane density estimations output from the lane density estimation module 251 are input into the simulation module 252. The simulation module 252 is configured to utilize the lane density estimations to create a simulation of the potential effects of a vehicle's mitigative control action, such as lane change, on each lane in the roadway and how that action may propagate to impact traffic on the road. The simulation module 252 is configured to execute the algorithms, processes, and functions needed to perform various forms of traffic simulations, including generating a simulation model that is aimed to accurately recreate traffic as observed and predict changes to the traffic in response to anticipated actions. Generally, simulation models generated by the simulation module 252 can focus on output values related to traffic that include, but are not limited to: traffic flows (e.g., based on the number of vehicles) and using the simulation model to devise how to reduce the levels of congestion of certain roads; and traffic simulations consisting of link, merge, link cross and other elements of the road (e.g., geometric layout of the road) using traffic simulations to estimate how traffic geometry and anticipated actions can influence the current traffic situation. Accordingly, the mitigative action selection system 250 leverages simulations of traffic which model any control actions (e.g., requested maneuvers, and maneuvers suggested by the system 250 to mitigate congestion), such as cooperative lane change maneuvers, to predictively simulate the impact of these actions on the traffic, and ultimately select the mitigative control action(s) that have the least adverse impact on traffic. In some cases, traffic simulation created by the simulation module 252 can be used for other traffic related purposes, such as traffic assessment, time and cost of travel, traffic improvement, and the like.

Thus, the estimation generated by the simulation module 252 can generate simulation models for traffic that include a microscopic level (e.g., microscopic modelling), which simulates the vehicles within the ego vehicle's vicinity, and a macroscopic level (e.g., macroscopic modelling), which applies the received lane density estimations. As an example, the simulation module 252 can receive data indicating that the lane directly adjacent to the ego vehicle has a high traffic density, for instance having a high number of vehicles that are currently traveling a high speed in the lane. As a result of analyzing this information, the simulation module 252 may generate a simulation estimating that a potential lane-change of the ego vehicle into the adjacent lane with high traffic density can adversely disturb traffic in that lane (e.g., causing traffic congestion), and further yields a dangerous increase in crash risks.

The simulation module 252 can be configured to generate a simulation corresponding to each anticipated/suggested maneuver and showing a simulated effect that the particular anticipated/suggested maneuver has on each lane in the roadway's geometry. For instance, if the vehicle receives a maneuver message from a nearby vehicle requesting to move to a center lane, the simulation module 252 particularly simulates this anticipated/suggested lane change action for the requesting vehicle. Further, the simulation module 252 generates a simulation which models the impact that the vehicle's anticipated move to the center lane has on each of the lanes in the road (and any vehicles present in the respective lanes), not just the center lane. Thus, a simulation created by the simulation module 252 captures any potential propagation of impact to the surrounding lanes, not merely the lane that directly corresponding to the anticipated/suggested action.

Moreover, the simulation module 252 can be configured to generate a simulation for multiple anticipated/suggested maneuvers, such as in the case of cooperative maneuvers, and showing a simulated affect that each maneuver performed by each vehicle has on the lanes in the roadway's geometry. For example, in a scenario where the anticipated/suggested control actions include a requested lane change maneuver into a middle lane by a nearby vehicle, and an a separate lane change maneuver out of the middle lane by an ego vehicle (e.g., making space for the nearby vehicle requesting to enter the middle lane) the simulation module 252 can generate a simulation estimating the impact that both lane changes made by both vehicles have on each lane. In some embodiments, the simulation module 252 generates multiple simulations for cooperative mitigative actions. For instance, the simulation module 252 can generate a simulation for each vehicle or anticipated/suggested maneuver involved the coordination of maneuvers for cooperative mitigative actions, which allows a degree of independent modeling and analysis to be conducted for each action that may be performed.

In particular, FIG. 2 depicts the simulation module 252 outputting traffic simulations (e.g., simulated models) and information that includes the simulated trajectories of vehicles, and various performance parameters relating to traffic, such as string instability index, attenuation decrement, acceleration/deceleration, time-to-collision, etc.

As seen in FIG. 2, the output from the simulation module 252 can then be received as input by the action selection module 253. Generally, the mitigative action selection system 250 selectively determines one or more mitigative actions for a vehicle that are deemed optimal for the driving environment, for instance allowing a vehicle to maneuver in a manner that reduces and/or avoids traffic congestion. By leveraging the information that is cooperatively received from other communicatively connected vehicles (e.g., vehicles sharing the roadway in the same vicinity) the action selection module 253 can more accurately select at least one mitigative control action that is most appropriate for maintaining smooth traffic flow (e.g., mitigate traffic congestion), based on simulations and predictions on the impact that the selected action may have on traffic.

According to the embodiments, the action selection module 253 is configured to evaluate a cost function, such as a disturbance attenuation decrement (λ), for each lane. The cost function quantitatively indicates the adverse impact that an anticipated/suggested maneuver has on the respective lane. For instance, a smaller value of the cost function indicates a lower probability of traffic congestion (e.g., traffic disturbance is attenuated) associated with performing the mitigative control action in that lane, and a smaller value of the cost function indicates a greater probability of traffic congestion (e.g., traffic disturbance is increased/amplified) associated with performing the mitigative control action in that lane. Accordingly, the action selection module 253 is configured to take an anticipated/suggested maneuver, evaluate the cost functions for all of the lanes in the road (based on the simulations), and select to perform the anticipated/suggested maneuver in the lane with the lowest value for the cost function. Thus, by seeking to lower (e.g., decrement) the cost function, the action selection module 253 selects the mitigative control action that achieves attenuation of disturbance and has the lowest potential to cause traffic congestion.

Additionally, the action selection module 253 can measure the increase (e.g., amplification) or decrease (e.g., attenuation) of disturbances by observing various traffic metrics related to the action, such as the estimated peak-to-peak acceleration (or the peak-to-peak velocity) fluctuations of vehicles upstream of the ego vehicle in the lane in response to the action. By performing the appropriate analysis, such as evaluating cost functions, observing metrics, and analyzing simulations, the action selection module 253 ultimately selects the mitigative control action, for instance deciding whether a vehicle performs a lane change maneuver or performs a deceleration maneuver in its current lane, in order to optimally mitigate traffic congestion.

Also, FIG. 2 illustrates that the action selection module 253 produces output that can include, but is not limited to: control commands for the ego vehicle (related to the particular mitigative control action that has been selected) that are transmitted to a vehicle controller 220; and messages (related to the particular mitigative control action that has been selected) that are transmitted to the wireless transmitter 225 which can then be communicated via vehicular wireless connectivity technology to other nearby connected vehicles. The action selection module 253 is configured to generate the appropriate control commands for controlling function of the vehicle, such as commands for executing an autonomous (or semi-autonomous) vehicle action. The control command is output from the action selection module 253 and instructs the vehicle controller 220 to execute actions, such as effectuating movement of various vehicle components, in order to ultimately perform the selected mitigative control action. As illustrated in FIG. 2, the vehicle controller 220 can effectuate control of the vehicle's electro-mechanical systems such as the throttle, brakes, steering, and the like, which ultimately command control of acceleration/deceleration, angular turning (e.g., steering), and various other movement and/or maneuvering functions of the vehicle.

Generally, the control commands trigger automated (or semi-automated) maneuvers of the ego vehicle such that collisions, traffic congestion slowdowns, and road closures are avoided. For example, in the case where the action selection module 253 determines that it is optimal for the ego vehicle to perform a lane change to avoid causing heavy traffic congestion within the lane it is currently traveling, the action selection module 253 may generate corresponding control commands. Particularly, the action selection module 253 generates control commands which instruct the vehicle controller 220 to execute automated functions (vis-à-vis the braking system and steering system) that ultimately perform the selected lane change maneuver, such as automatically engaging the vehicle's brakes to decrease speed, and engaging the steering system to the turn the vehicle into the adjacent lane. It should appreciated that the mitigative action selection system 250 is not limited to autonomous vehicle actions, and in some embodiments can alternatively prompt the driver to execute the selected maneuvers or additional actions that supplement the maneuver (e.g., signaling for a lane change). As an example, the action selection module 253 may generating one or more alerts (e.g., a visual alert displayed on the vehicle head unit, or an audible alter) that notify the driver to manually perform actions related the selected mitigative action (e.g., deceleration, lane change, etc.) in lieu of or in addition to the automatically generated control commands.

FIG. 2 illustrates that the action selection module 253 can also generate messages, which are intended to be communicated to other communicatively connected vehicles in relation to the mitigative control action. As shown in the example of FIG. 2, the action selection module 253 outputs intent messages to the vehicle's wireless transmitter 225. Intent messages are a form of notification and/or alert that allows for other connected vehicles to anticipate upcoming mitigative maneuvers to be performed by the ego vehicle. Particularly, an intent message includes information regarding the anticipated/suggested maneuver to be performed by the ego vehicle which is communicated to other connected vehicles. For example, continuing with the example of a lane change being selected as the mitigative control action, the action selection module 253 can communicate an intent message to one or more connected vehicles that are currently traveling in a certain lane, indicating the intention of the ego vehicle to move into that same lane when executing its lane change maneuver. In some embodiments, the action selection module 253 is configured to select a particular group of connected vehicles to which the intention messages are communicated to (e.g., multicast transmission) as a means to reduce network overhead. For instance, the action selection module 253 may only transmit an intention message to the connected vehicles that are directly impacted by the selected mitigative control action (e.g., in the same lane as the destination of a lane change maneuver). Alternatively, in some embodiments, the action selection module 253 is configured to communicate the intention messages to all connected vehicles that have such communication capabilities and are within the wireless range (e.g., broadcast transmission).

In some embodiments, the intent message transmitted by the vehicle implementing the mitigative action selection system 250 (vis-à-vis the wireless transmitter 225), can trigger for other functions. For example, a connected vehicle receiving an intent message (e.g., the vehicle's controllers processing the message) can generate notifications, warnings, alerts, and other visual, audio, and tactile outputs in anticipation of the ego vehicle executing the selected mitigative maneuver. In some implementations, the messages that are communicated to other connected vehicles further also effectuate automated (or semi-automated) maneuvers of these connected vehicles.

Additionally, FIG. 2 shows that the action selection module 253 can output maneuver request messages to the vehicle's wireless transmitter 225. Maneuver request messages can be a form of alert and/or notification that includes information regarding an anticipated/suggested maneuver for another vehicle (e.g., not the ego vehicle), for instance in a cooperative mitigative action, to be communicated to other connected vehicles. As an example, continuing with the example of a lane change being selected as the mitigative control action, the action selection module 253 may further determine that a communicatively connected vehicle that is currently traveling in the ego vehicle's destination lane (e.g., the lane that the ego vehicle will move to in result of the lane change maneuver) can slightly decelerate in order to make an open space in the lane for the ego vehicle, in a manner that mitigates congestion and/or a potential collision. Thus, because this is a cooperative mitigative action that involves coordinated maneuvering between the ego vehicle and another nearby vehicle, the action selection module 253 can communicate a maneuver request message to that connected vehicle, requesting for the connected vehicle slowdown in the lane, allowing the ego vehicle to move into that same lane when executing its lane change maneuver. In some embodiments, the action selection module 253 is configured to communicate one or more maneuver request messages, for example wirelessly transmitting (vis-à-vis the wireless transmitter 225) a maneuver request message to each vehicle that is involved the selected cooperative maneuver. Each maneuver request message includes the particular action that is to be performed as a part of the cooperative mitigative maneuver (that is coordinated between multiple vehicles), for the respective vehicle receiving the message.

In some embodiments, the maneuver request message transmitted by the vehicle implementing the mitigative action selection system 250 (vis-à-vis the wireless transmitter 225), can trigger for other functions. For example, a connected vehicle receiving a maneuver request message (e.g., the vehicle's controllers processing the message) can generate notifications, warnings, alerts, and other visual, audio, and tactile outputs indicating the maneuver that is being requested. In some implementations, the maneuver request messages that are communicated to other connected vehicles further also effectuate automated (or semi-automated) maneuvers of these connected vehicles in order to ultimately perform cooperative mitigative action, in a manner that actively manages traffic congestion.

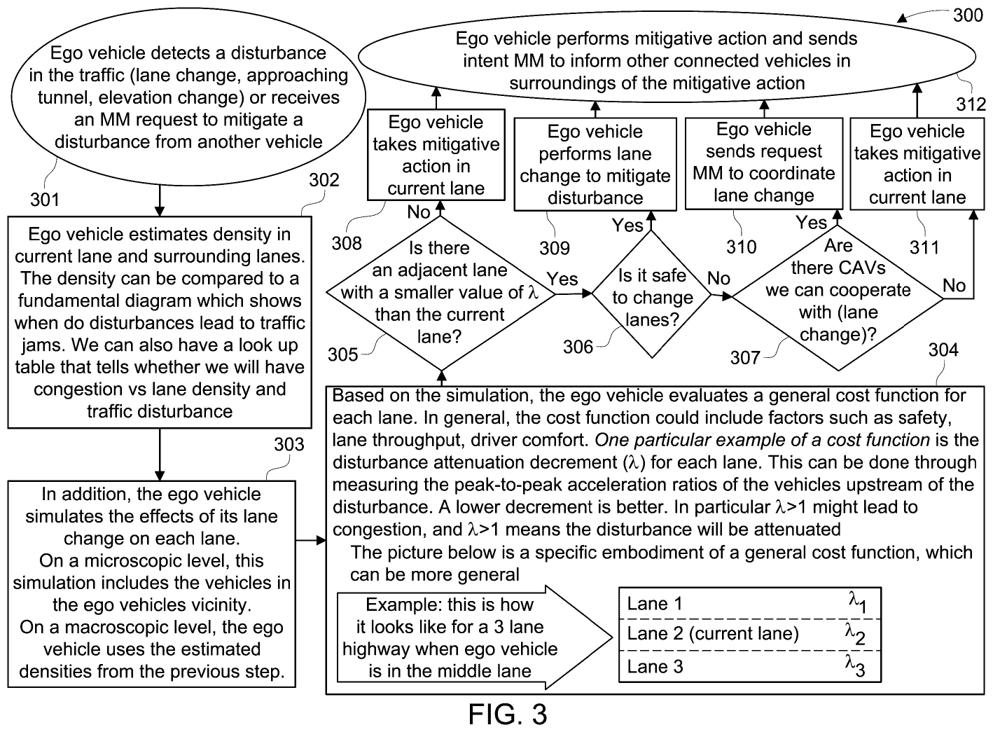

FIG. 3 is a flow diagram of an example method, depicted as process 300, that is performed according to one embodiment of the systems and methods described herein. The process 300 can be a series of executable operations in a machine-readable storage media performed by a hardware processor. A computing component can be a computer device used for implementing the disclosed mitigative action selection functions described herein. For example, the computing component may be the controller of a vehicle implementing the mitigative action selection system described above in reference to FIG. 1. As a general description, process 300 depicts a method for implementing a simulation-based approach of mitigative action selection, as disclosed herein, where the possible outcomes from a mitigative action are simulated and the scenario with the best outcome (e.g., optimal cost function) is selected.

The process 300 can begin at operation 301 where the ego vehicle detects a disturbance in the in the vehicle traffic, for instance on a road or highway. For example, the ego vehicle may detect a lane change, an approaching tunnel, or elevation change. Due to the disturbance, the ego vehicle may receive an MM request from another vehicle within the vicinity to mitigate the disturbance.

Thereafter, the process 300 can continue to operation 302 where the ego vehicle estimates a density for a current lane (e.g., the lane the ego vehicle is currently traversing) and other adjacent/surrounding lanes. As an example, in a scenario where the ego vehicle is traveling along a three-lane (e.g., travel in the same direction) highway, operation 302 may include the ego vehicle estimating an individual density for each of the three lanes of the highway. In an embodiment, operation 302 can involve comparing the density to a fundamental diagram, which shows when the disturbances can lead to a traffic jam. Additionally, operation 302 can involve implementing a look up table that indicates whether there will be congestion, based on the determinations of lane density and traffic disturbances.

Next, the process 300 goes to operation 303 where the ego vehicle simulates the effects of a mitigative action, such as a lane change, on each of the adjacent/surrounding lanes. On a microscopic level, the simulation generated in operation 303 includes, at least, the vehicles that are within a vicinity (e.g., defined radius) of the ego vehicle. On a macroscopic level, the ego vehicle uses the estimated densities from previous operation 302 to generate the simulation in operation 303. After the simulation, the process 300 progresses to operation 304.

At operation 304, the ego vehicle evaluates a general cost function for each of the adjacent/surrounding lanes, based on the simulation performed in previous operation 303. The cost function can include factors such as safety, lane throughput, driver comfort, and the like. In an embodiment, the cost function implemented in operation 304 is a disturbance attenuation decrement (A). Accordingly, operation 304 can include calculating an individual disturbance attenuation decrement value for each of the adjacent/surrounding lanes. For instance, referring back to the three-lane highway example, operation 304 can generate: a λ₁ value corresponding to a first lane; a λ₂ value corresponding to a second lane; and a λ₃ value corresponding to a third lane. Furthermore, evaluating disturbance attenuation decrement (as the cost function) can involve measuring the peak-to-peak acceleration ratios of the vehicles upstream of the disturbance. As previously described, an approximately low value for disturbance attenuation decrement (e.g., λ<1) evaluated in operation 304 indicates that the disturbance will be attenuated (by the mitigative action), while an approximately higher value for disturbance attenuation decrement (e.g., λ>1) indicates that the disturbance will be and lead to congestion (by the mitigative action). The process 300 then continues to operation 305.

A conditional check is performed in operation 305 to determine which is the optimal lane for performing the mitigative action. That is, operation 305 compares each of the values calculated in previous operation 304 to determine whether there is an adjacent lane with a lower disturbance attenuation decrement value (A), in comparison to the value corresponding to the current lane. In the case where operation 305 determines that there is no adjacent lane with a smaller disturbance attenuation decrement value (e.g., the current lane has the lowest A) (shown as “No” in FIG. 3) then the process 300 moves to operation 308 and does not perform a mitigative action in the current lane. Subsequently, from operation 308, the process 300 proceeds to operation 312. Then, at operation 312, the ego vehicle performs the mitigative action and sends intend MM to inform other communicatively connected vehicles in the adjacent/surrounding lanes of its mitigative action.

Referring back to operation 308, in the case where the conditional check determines that there is a lane with a lower disturbance attenuation decrement value (A) (shown in FIG. 3 as “No”), then the process 300 steps to operation 306 and executes another conditional check to determine whether it is safe for the vehicle to maneuver to another lane.

At operation 306 it is determined whether it is safe for the vehicle to change lanes, for instance maneuvering to the lane with the lowest disturbance attenuation decrement value (A). If operation 306 determines that it is safe to change lanes (shown as “Yes” in FIG. 3), then the process 300 goes to 309 and executes the optimal action, where the ego vehicle performs a lane change (into the lowest attenuation lane) to mitigate the disturbance. Thereafter, the process 300 goes to operation 312 where the ego vehicle performs the mitigative action and sends intend MM to inform other communicatively connected vehicles in the adjacent/surrounding lanes of its mitigative action.

Referring again to operation 306, if the check determines that it is not safe to change lanes (shown as “No” in FIG. 3), then the process 300 moves on to 307 and performs yet another condition check.

Operation 307 involves determining whether it is possible to execute a cooperative mitigative action with one or more connected vehicles. For example, operation 307 can include detecting the presence of any other communicatively connected vehicles within the vicinity of the ego vehicle (e.g., operable communication range of network technology and/or in adjacent lanes) that also have mitigative action selection capabilities. If there are other connected vehicles within the vicinity, as determined by operation 307, then process 300 continues to operation 310. Because there is the potential to execute a cooperative maneuver with other connected vehicles, operation 310 involves the ego vehicle communicating a MM request to the one or more detected connected vehicles to perform a cooperative mitigative action, for instance performing a coordinated lane change which achieves the optimal disturbance attenuation. Next, the process 300 goes to operation 312, where the ego vehicle performs the mitigative action and sends intend MM to inform other communicatively connected vehicles in the adjacent/surrounding lanes of its mitigative action.

However, returning back to operation 307, if it is determined that there are no communicatively connected vehicles in the vicinity with which to perform a cooperative mitigative action (shown in FIG. 3 as “No”), then the process 300 continues to operation 311 and executes the mitigative action in the current lane. Subsequently, from operation 311, the process 300 proceeds to operation 312 and the ego vehicle performs the mitigative action and sends intent MM to inform other communicatively connected vehicles in the adjacent/surrounding lanes of its mitigative action.

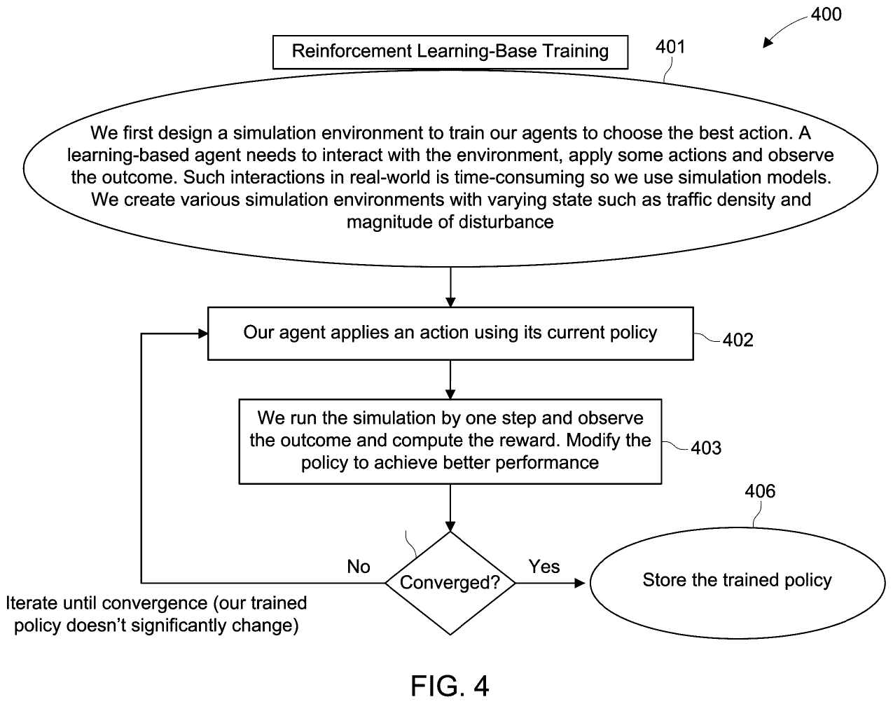

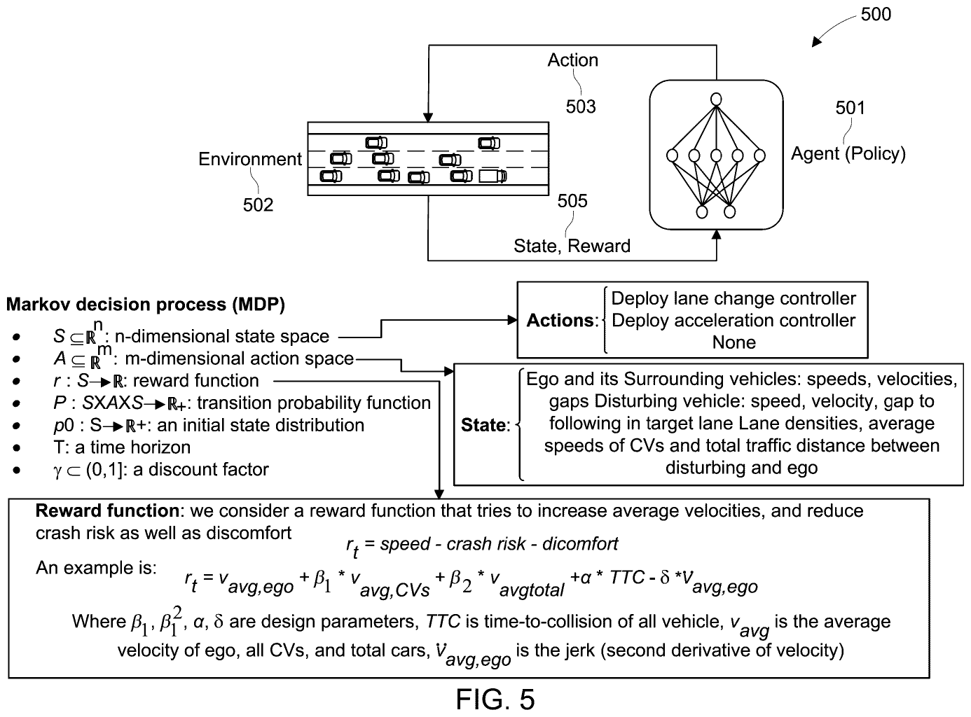

FIG. 4 is a flow diagram of another example method, depicted as process 400, that is performed according to one embodiment of the systems and methods described herein. The process 400 is a method for implementing training for a learning-based approach of mitigative action selection techniques, as disclosed herein. A learning-based approach leverages artificial intelligence (AI)/machine learning (ML) mechanisms in order to select an optimal mitigative action for mitigating disturbance, as opposed to the previous method described in reference to FIG. 3 which utilizes simulation. In process 400, an AI/ML agent (also referred to herein as a policy) can be trained learn a best action. Then, in order to select the optimal mitigative action, the trained AI/ML model can make a decision for selecting the most optimal mitigative action based on the current state information without it being necessary to simulate all of the potential scenarios. In some embodiments, the method 400 implements a reinforcement learning-based training. FIG. 5 illustrates the process 400 in a conceptual diagram. It should be understood that the learning-based mitigative action selection processes, as disclosed herein, are capable of utilizing other forms of machine learning, artificial intelligence, and learning based computation without departing from the scope of the embodiments, including but not limited to: neural networks; artificial neural networks (ANNs); simulated neural networks (SNN); convolutional neural networks (CNNs); and the like.

The process 400 can be a series of executable operations in a machine-readable storage media performed by a hardware processor. A computing component can be a computer device used for implementing the disclosed mitigative action selection functions described herein. For example, the computing component may be the controller of a vehicle implementing the mitigative action selection system described above in reference to FIG. 1. In another implementation, the computing component executing process 400 is a computer system that is external to the vehicle, such as an edge/cloud server, which can perform the training of the AI/ML agent remotely before it is subsequently deployed to the vehicle for use.

Process 400 can begin at operation 401, where an AI/ML agent is trained using a simulation environment. In an embodiment, the operation 401 involves designing a simulation environment to train the AI/ML agent how to select an optimal mitigative action for a particular traffic scenario. Various simulation environments can be used to train the AI/ML agent, where each simulation has varying states, such as traffic density and magnitudes of disturbances, in order to train the AI/ML agent over a robust set of potential real-world traffic environments. The AI/ML agent can interact with the simulated environment, applying known mitigative actions to the environment and observing the corresponding outcomes in order to learn over time the impact certain mitigative actions have in various scenarios. For instance, the AI/ML agent can be trained to predict each outcome that a mitigative action will have on a currently observed traffic scenario, which enables the AI/ML agent to ultimately learn how to select the most optimal mitigative action resulting in the least amount of disturbance and/or mitigating traffic congestion.

Subsequently, at operation 402, the AI/ML agent applies a mitigative action using its current policy. Then, process 400 continues to operation 403 to run the simulation and observe the outcome. In some cases, operation 403 involves calculating the performance of the AI/ML model's policy. Based on the observed outcome, the policy can be modified in order to achieve a better performance. In FIG. 5, training process 500 of the AI/ML agent 501 is particularly depicted a Markov Decision Process (MDP). In this example, actions 503 that can be injected into the simulation environment 502 include: deploy lane change; deploy acceleration; and none. Further, states associated with the simulation environment 502 can include: ego vehicle and surrounding vehicles (e.g., speeds, velocities, gaps, etc.); the disturbing vehicle (e.g., speed, velocity, gap to following in target lane); lane densities; average speeds of connected vehicles; total traffic distance between ego vehicle and disturbing vehicle. FIG. 5 also shows that the MDP training 500 involves observing the outcome corresponding to the applies action 503 and calculating a reward 505, utilizing a reward function, for a particular state of the simulation environment 502 which governs the performance of the AI/ML agent 501. For instance, a reward function of the AI/ML agent 501 can be implemented that tries to increase average velocities, and reduce crash risk as well as discomfort. Accordingly, the MDP training process 500 can be iteratively performed in a manner that allows the AI/ML agent 501 to be trained to select actions that yield the highest reward.

The process 400 proceeds to operation 404 and executes a conditional check to determine whether the AI/ML agent converges, and has a stable performance. If operation 404 determines that the AI/ML agent does not converge (shown as “No” in FIG. 4), then the process 400 returns to operation 402 iteratively performs operations 402-404 until the policy is found to converge in operation 404. The AI/ML agent can be considered to have a lack of convergence when there it is a substantive change in learning rate, low performance, and/or high rate of errors. For example, operation 404 may determine that the AI/ML agent do not converge if there is a substantive amount of changes in learning for the same simulated environment.

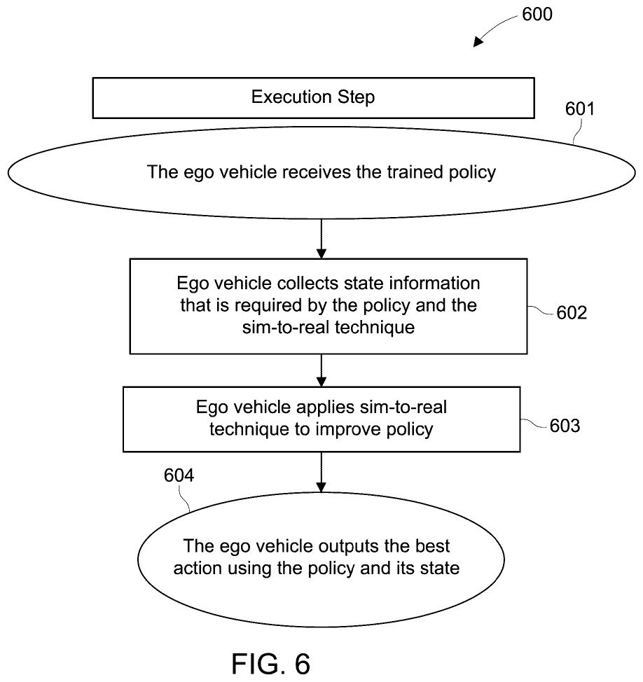

When operation 404 does determine that the AI/ML agent converges (shown as “Yes” in FIG. 4), then it is deemed that the AI/ML agent is stable and its policy is stored in operation 406. For example, convergence can be determined in operation 404 when training the AI/ML agent reaches a point of where changes in the learning rate become lower and the errors (e.g., loss) produced by the AI/ML agent comes to a minimum. Consequently, the process 400 trains an AI/ML agent for a wide-range of traffic scenarios, where the trained AI/ML agent can then be leveraged to achieve an efficient learning-based mitigative action selection method, depicted in FIG. 6.

Referring now to FIG. 6, a flow diagram of another example method, depicted as process 600, that is performed according to one embodiment of the systems and methods described herein. The process 600 is a method for implementing learning-based mitigative action selection techniques, as disclosed herein. Generally, the process 600 is a real-world implementation of the AI/ML agent that was trained by the method of FIG. 4.

The process 600 can be a series of executable operations in a machine-readable storage media performed by a hardware processor. A computing component can be a computer device used for implementing the disclosed mitigative action selection functions described herein. For example, the computing component may be the controller of a vehicle implementing the mitigative action selection system described above in reference to FIG. 1.

The process 600 begins at operation 601 where the ego vehicle receives the trained policy. For example, after training, the trained model is deployed to the vehicle for use in real-world. Operation 601 can include transferring the trained policy from simulation to real-world which can be accomplished using sim-to-real techniques.

Then, the process 600 proceeds to operation 602, where the vehicle collects current state information. State information is used by the policy and the sim-to-real techniques. Examples of current state information that may be collected by the ego vehicle include, but are not limited to: velocities; gaps; magnitude of the disturbance, and the like.

Subsequently, at operation 603, the ego vehicle applies sim-to-real technique to improve the policy. Thereafter, the process continues to operation 604.

At operation 604 the ego vehicle outputs the most optimal (best) mitigative action using the policy and its current state collected in previous operation 602. Consequently, operation 600 executes learning-based mitigative action selection functions, for instance in an ego vehicle, in accordance with one embodiment of the systems and methods described herein.

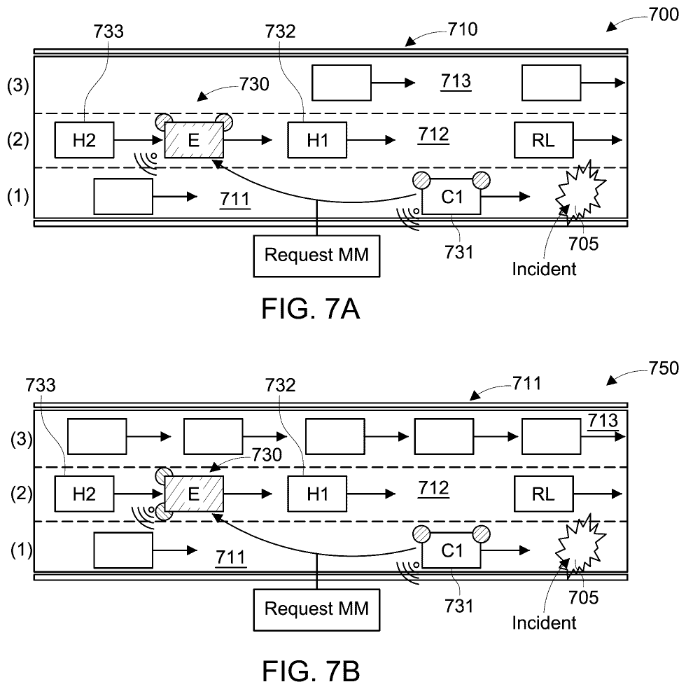

FIG. 7A depicts an example environment 700 showing an operational example of how the mitigative action selection system and functions (shown in FIG. 1) may operate in a particular traffic scenario. As previously described, a mitigative action selection system can be implemented as a computing device (e.g., controller) of an ego vehicle 730, in accordance with an embodiment. In the example environment 700 of FIG. 7A, an incident 705 has occurred on a highway 710. Particularly, FIG. 7A shows the incident 705 as being located in lane 711 of the three-lane highway 710. In order to avoid the incident 705, it may be desirable for the vehicle 731 (which is also traveling in the same lane 711 as the incident 705) to move into adjacent lane 712. However, if vehicle 731 does execute a lane change maneuver to enter into lane 712, this may disturb vehicles 730, 732, and 733 that are currently operating in lane 712 and can potentially lead to further traffic congestion along highway 710. Accordingly, prior to executing the potentially traffic disturbing maneuver, vehicle 731 can send a request to vehicle 730 (having mitigative action selection capabilities) in order to perform disturbance mitigation in this scenario. Particularly in the example of FIG. 7A, lane 713 of the highway 710 has low density, meaning there are few vehicles that are currently occupying that lane 713. Because the low density of lane 713 can be detected, the ego vehicle 730 can leverage this information about the current traffic environment 700 in its mitigative action selection process, and determine that it is optimal in this scenario for two vehicles 730, 731 to perform coordinated lane changes as a cooperative mitigative action. That is, the cooperative mitigative action includes vehicle 730 performing a first lane change maneuver (of the cooperative mitigative action) to move into lane 713 (from lane 712), which creates a gap between vehicles 732 and 733 in lane 712, ultimately dampening any disturbance which would be created by the vehicle 731 executing a second lane change maneuver (of the cooperative mitigative action into lane 712. That is, when vehicle 731 changes lanes to avoid the incident 705 in lane 711 and enters lane 712, vehicle 730 will have already moved out of that lane 712 (into lane 713). This creates enough space in lane 712 to ensure that the vehicles 732, 733 that are being driven behind vehicle 731 in lane 712 are not substantially disturbed (e.g., not traffic congestion) and avoids sudden and/or dangerous reactions (e.g., hard brake, sudden lane change) that drivers of those vehicles would have to make if vehicle 731 had made a less safe/optimal lane change.

FIG. 7B depicts another example environment 750 to illustrate an operational example of how the mitigative action selection system (shown in FIG. 1) may function in a particular traffic scenario. The example environment 750 is substantively similar to the previous example environment described in FIG. 7A above, having vehicles 730-733 and an incident 705 that has occurred on a highway 710. However, in the traffic environment 750, lane 713 of the highway 710 has a high density (as opposed to a low density in the example of FIG. 7A), with many vehicles currently traveling in that lane 713. In this example, vehicle 730 can detect that lane 713 has a high traffic density. As a result, vehicle 730 can determine that a vehicle moving into that lane 713 will disturb traffic in a manner that may cause traffic congestion on the highway 710 and potentially even cause a dangerous collision with other vehicles operating in lane 713. In particular, if vehicle 730 executed the same lane change into lane 713 that was performed in the previous example of FIG. 7A while lane 713 has such high density, that the action would pose an extremely increased crash risk which can cause damage to vehicles and human injury. Accordingly, the mitigative action selection capabilities enable vehicle 730 to select an cooperative mitigative action, where actions are coordinated between the two vehicles 730, 731 in a manner that is deemed most optimal for the particular scenario. The first aspect of the cooperative mitigative action involves vehicle 730 decelerating to provide a gap with vehicle 732 in lane 712. The generated gap between vehicles 730 and 732 in lane 712 provides enough open space in the lane to allow vehicle 731 to perform the second aspect of the cooperative mitigative action, which is a lane change maneuver into lane 712, by moving directly into the open area (formed by vehicle's 730 prior deceleration), thereby damping any disturbance that otherwise would have been created by vehicle 731 executing a less safe/optimal lane change.

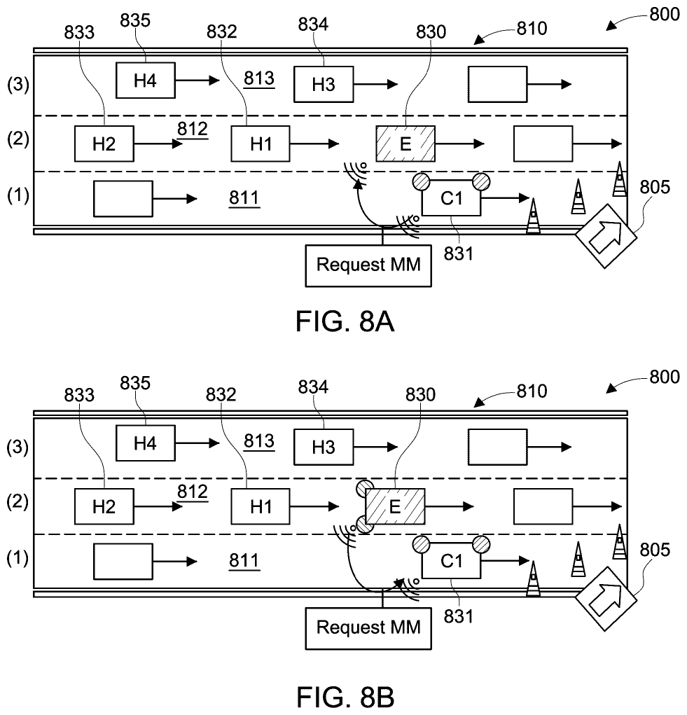

FIGS. 8A-8B depict another example environment 800 to illustrate an operational example of how the mitigative action selection system (shown in FIG. 1) may function in a particular traffic scenario. An ego vehicle 830 can implement a mitigative action selection system, implementing the disclosed functions, in accordance with an embodiment. In the example environment 800 in FIGS. 8A-8B, there is a work zone 805 in the lane 811 of the three-lane highway 810. Thus, it may be desirable for vehicle 831 which is currently traveling along lane 811 to perform a lane change in order to avoid the work zone 805, and move to the adjacent lane 812. However, vehicle 831 executing the intended lane change into lane 812 may have an impact that disturbs traffic, for instance causing the traffic in lane 812 to slow down, potentially leading to traffic congestion. FIG. 8A shows that vehicle 831 can send a MM request to ego vehicle 830 to leverage its mitigative action selection capabilities to mitigate the potential disturbance its lane change could cause.

In the scenario depicted in FIGS. 8A-8B, lane 812 and lane 813 have roughly the same density. Accordingly, ego vehicle 830 can employ its mitigative action selection functions, as disclosed herein, to determine the mitigative actions that are deemed most optimal for mitigating disturbance for this specific scenario. That is, to mitigate any disturbance to vehicles 833, 833 (which are behind vehicle 830), for instance drivers of these vehicles having to abruptly brake and/or decelerate when vehicle 831 enters into lane 812. Ego vehicle 830 can calculate the mildest possible acceleration that it can use to increase its distance from vehicle 832, which provides enough open space in lane 812 to accommodate vehicle 831 moving into that lane 812 (e.g., lane change maneuver performed by vehicle 831 to avoid the work zone 805 in lane 811), while ensuring that no conflict occurs between 831 and 830. In the example of FIGS. 8A-8B, the ego vehicle 830 can implement the simulation-based mitigative action selection process disclosed herein (e.g., described in greater detail in reference to FIGS. 2-3). For instance, ego vehicle 830 can have an on-board simulation using a human car following model (with human reaction delay and parameter uncertainties considered) in accordance with the simulation-based mitigative action selection techniques disclosed, which shows that under the mildest acceleration it can use, the acceleration that human driven vehicles 832, 833 will use becomes even milder. This scenario leads to a small disturbance attenuation decrement λ₂<1. Continuing with the example, the ego vehicle 830 can perform a similar simulation for determining the impact of vehicle 830 performing a lane change into lane 813. For instance, the simulation of vehicle's 830 lane change can show that this action leads to hasher braking of human driven vehicles 834, 835 in lane 813, and a higher disturbance attenuation decrement λ₃>1. This greater disturbance may happen because of the relative shorter distance between vehicle 834 in lane 813 and vehicle 830 in lane 812. Thus, even with roughly the same density in lane 812 and lane 813, the disclosed mitigative action selection techniques enable the ego vehicle 830 to select an mitigative action that is most optimal for the particular scenario, which is vehicle 830 decelerating in its current lane 812, rather than performing a lane change maneuver into adjacent lane 813 (e.g., since λ₂<λ₃). FIG. 8B shows vehicle 830 communicating a response MM to vehicle 831, indicating the mitigative action that has been selected. That is, vehicle 831 can be notified of the cooperative mitigative action, where vehicle 831 can perform its lane change maneuver and move into lane 812 (to avoid the work zone 805) after vehicle 830 has decelerated.

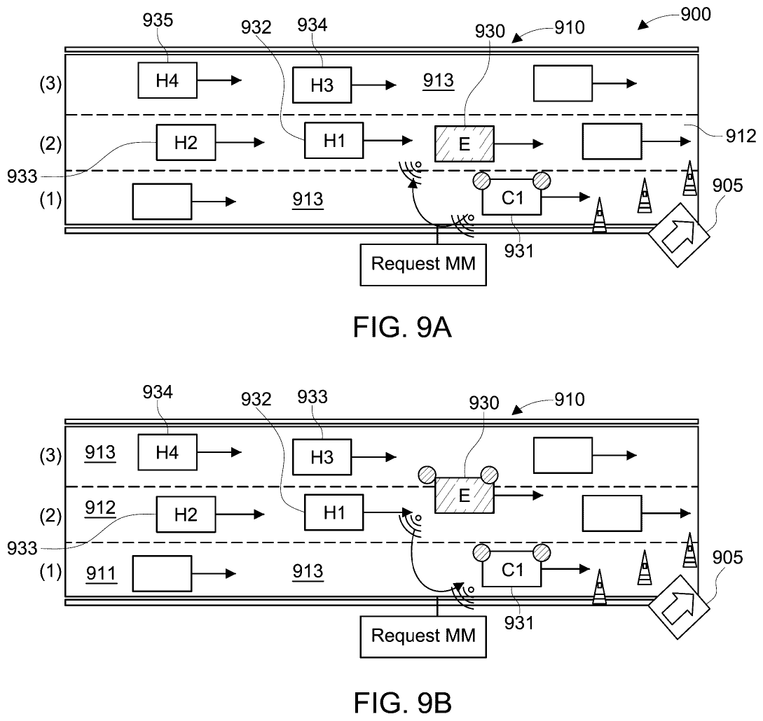

FIGS. 9A-9B depict an example environment 900 to illustrate yet another operational example of how the mitigative action selection system (shown in FIG. 1) may function in a particular traffic scenario. The ego vehicle 930 can implement the mitigative action selection system and functions, as disclosed herein. In the example environment 900 of FIGS. 9A-9B, a work zone 905 is in lane 911 on a highway 910. Thus, in order to avoid the work zone 905, vehicle 931 may desire to perform a lane change maneuver into the adjacent lane 912. FIG. 9A shows vehicle 931 sending a MM request to vehicle 930 to perform disturbance mitigation based on the intended lane change, where the ego vehicle 930 has the capability to select the optimal mitigative action for this scenario.

As seen in FIGS. 9A-9B, there are two human-driven vehicles 932, 933 that are following the ego vehicle 930 in lane 912, which may be possibly disturbed by vehicle 931 also entering into that lane 912 in an attempt to avoid the work zone 905 in lane 911. Thus, in order to mitigate the braking behaviors of human-driven vehicles 932, 933 that are traveling behind the ego vehicle 930 in lane 912, the vehicle 830 can first calculate the mildest possible acceleration that it can use to accommodate vehicle 931 entering into lane 912, while ensuring that no conflict occurs between vehicle 931 and ego vehicle 930. The ego vehicle 930 can execute simulation-based mitigative action selection techniques, as disclosed herein (e.g., simulation-based mitigative action selection described in greater in FIGS. 2-3). Therefore, the ego vehicle 930 can have an on-board simulation using a human car following model (with human reaction delay and parameter uncertainties considered), where the simulation shows that under the mildest acceleration that ego vehicle 830 can use, the human-driven vehicles 931, 933 have to brake very harshly to ensure safety in order for vehicle 931 to move into lane 912. This action would lead to a large disturbance attenuation decrement λ₂>1 for lane 912. FIGS. 9A-9B illustrate that in this particular traffic environment 900, vehicle 932 (in lane 912) is traveling substantively close to vehicle 931 (in lane 911), and is traveling with a high rate of speed, which leads to the aforementioned harsh braking and large disturbance attenuation decrement for lane 912 for this action.

Furthermore, during its mitigative action selection process, the ego vehicle 930 can perform a second simulation to evaluate the impact of ego vehicle 930 performing a lane change maneuver into lane 913 (as opposed to the acceleration in lane 912 that is evaluated in the first simulation). This second simulation can reveal that human driven vehicles 934, 935 traveling in lane 913 will only need to use a mild acceleration to accommodate a vehicle 930 lane change, and that there is a small disturbance attenuation decrement λ₃<1 observed in the target lane 913 in response to this mitigative action. Thus, ego vehicle 930 executing a lane-change into lane 913 presents less disturbance than an acceleration action, in this particular scenario (as compared to previous example of FIGS. 8A-8B). Generally, the second simulation shows that the greater distance between vehicle 934 (in lane 913) and the ego vehicle 930 (in lane 912) has a lower potential of disturbance than the first simulation (for acceleration) where there is a very short distance between vehicle 932 (in lane 912) and the vehicle 931 (in lane 911). The disturbance to lane 913 is further lessened, as both vehicles 930, 934 are traveling at the proper relative speed for a lane-change maneuver, while vehicle 932 is operating at a higher speed (which can lead to a high disturbance for a lane change into lane 912). Thus, in this particular scenario for traffic environment 900, the ego vehicle 930 selects to perform a lane change maneuver into lane 913 as the optimal mitigative action, rather than accelerating in its current lane 912 (since λ₃<λ₂). Accordingly, the ego vehicle can select a cooperative mitigative action with vehicle 931, where the ego vehicle 930 executes a first lane change maneuver, moving into lane 913 from lane 912.

FIG. 9B shows the ego vehicle 930 communicating a response MM to vehicle 931, which can be an instruction that vehicle 931 is to coordinate its lane change maneuver into lane 912 after vehicle 930 has fully executed its lane change maneuver into lane 913. After the ego vehicle 930 exits lane 912, this creates an open space in lane 912 allowing vehicle 931 to subsequently perform its lane change maneuver into lane 912 safely (moving into the open area), avoiding the work zone 905, and with low disturbance to the traffic on the highway 910.

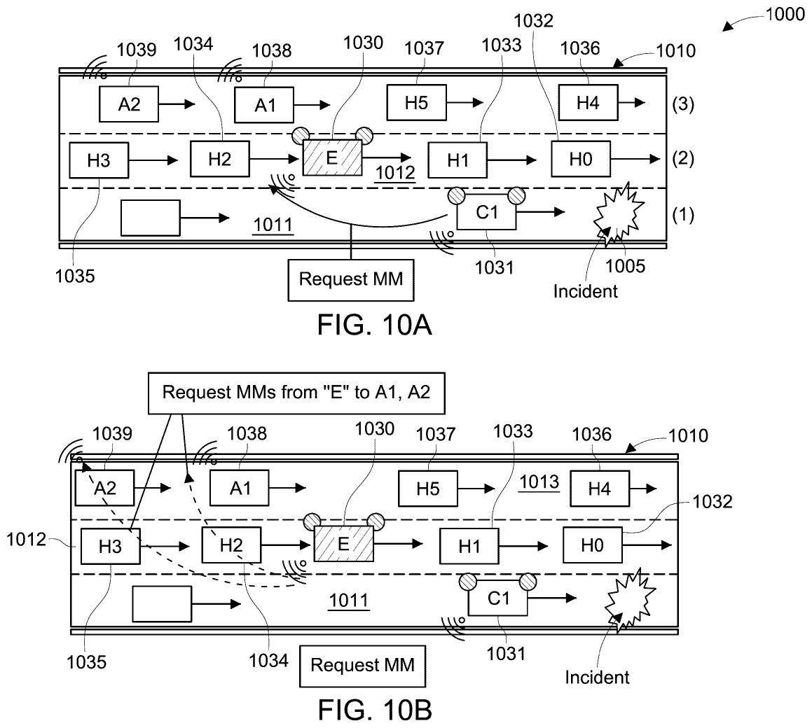

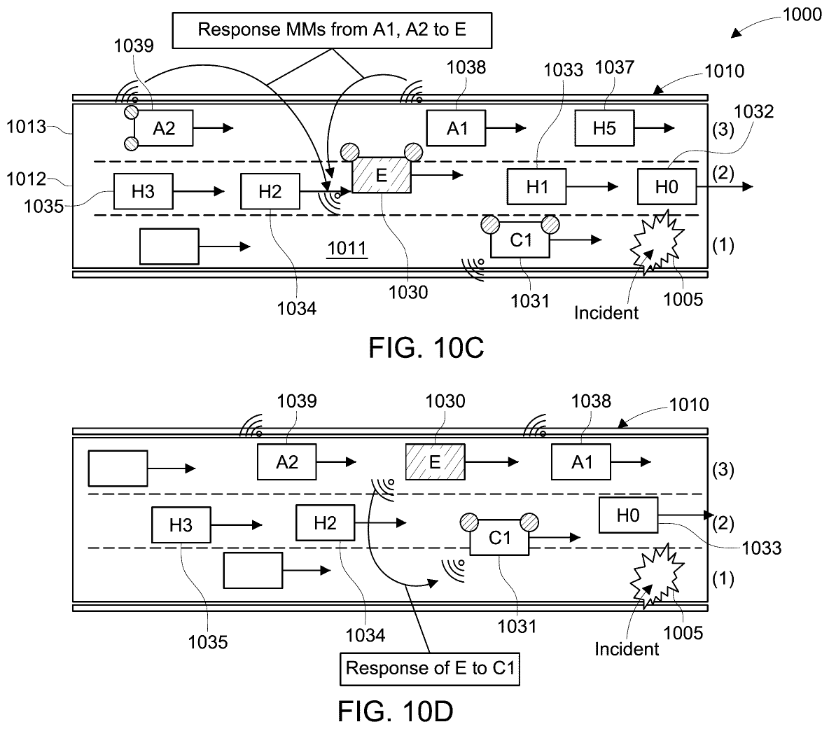

FIGS. 10A-10D depict yet another example environment 1000 to illustrate an operational example of how the mitigative action selection system (shown in FIG. 1) may function in a particular traffic scenario. An ego vehicle 1030 can implement a mitigative action selection system and functions, in accordance with an embodiment. In the example environment 1000 of FIGS. 10A-10D, there is an incident 1005 in lane 1011 on a three-lane highway 1010. Thus, in order to avoid the approaching incident 1005 in lane 1011, vehicle 1031 may desire to perform a lane change into adjacent lane 1012. Particularly in the traffic environment 1000 of FIGS. 10A-10D, there are two connected vehicles 1037, 1038 that are currently traveling in adjacent lane 1013 that are able to communicate with ego vehicle 1030 and cooperatively participate in the mitigative action selection process executed by the ego vehicle 930. In the example of FIGS. 10A-10D, the connected vehicles 1038, 1039 are autonomous vehicles. FIG. 10A also depicts that vehicle 1031 sends a MM request to ego vehicle 1030 prior to executing its intended maneuver, as the ego vehicle 1030 is currently in the target lane 1013 for vehicle 1031's proposed lane change. As seen in FIG. 10A-10B, the traffic environment 1000 also includes two human-driven, unconnected vehicles 1032-1035 that are being driven in lane 1012, and the two additional human-driven vehicles 1036, 1037 and the two connected automated vehicles 1038, 1039 operating in lane 1013.

In accordance with the mitigative action selection techniques, ego vehicle 1030 can determine that if it performs a mitigative action of changing lanes into lane 1013, then it will mitigate disturbance more so than performing an action in its current lane 1012 (e.g., acceleration/deceleration). However, ego vehicle 1030 can also determine that it is not currently safe to perform this lane change maneuver, as lane 1013 is not clear in the immediate area nearby vehicle 1030 and changing lanes at the current point in time has a high probability of causing a collision. Vehicle 1030 can make a determination regarding lane 1013 to this level of specificity, by leveraging the communication with connected vehicles 1038, 1039 that are in lane 1013. In other words, connected vehicles 1038, 1039 can provide supplemental data to ego vehicle 1030 and actively participate in the mitigative action selection process in cooperation with ego vehicle 1030.

FIG. 10B illustrates that ego vehicle 1030 can send an MM request to connected vehicle 1038 and connected vehicle 1039, respectively. In this scenario, ego vehicle 1030 can determine that it is optimal to execute cooperative mitigative actions, where connected vehicles 1038, 1039 can perform maneuvers in coordination with ego vehicle 1030 in a manner that allows the vehicle 1030 to both change lanes in the interest of mitigating the disturbance and performing driving maneuvers in a safe manner (e.g., avoiding collision). For example, the MM request sent to connected vehicle 1039 can request that the vehicle smoothly brakes in order to open up a gap in lane 1013, which subsequently allows space in between vehicles 1038, 1039 in the lane 1013 for vehicle 1030 to enter for its lane change maneuver. In this example, ego vehicle 1030 can wait for a determined amount of time allotted for allowing vehicle 1039 to slow down, before vehicle 1030 executes its mitigative action (e.g., lane change) and moves into lane 1013.

FIG. 10C particularly illustrates the point of time in environment 1000 when connected vehicles 1038, 1039 open up the gap allowing space for vehicle 1030 to execute its lance change maneuver, moving into target lane 1013. For instance, the gap is opened up by the connected vehicle 1039 autonomously decelerating smoothly in order to both make space for the ego vehicle's 1030 lane change and to avoid disturbing the traffic in lane 1013. FIG. 10C also depicts the ego vehicle 1030 initiating its merge into the open space in lane 1030 between the connected vehicles 1038, 1039 created by the cooperative mitigative action in order to facilitate a safe lane change (e.g., avoiding collision).

FIG. 10D illustrates a later point in time in the traffic environment 1000, where yet another aspect of the cooperative mitigative action is performed. FIG. 10D particularly depicts where the vehicle 1030 has completed its lane change maneuver, being safely in lane 1013, which then allows space for vehicle 1031 to finally merge into lane 1012 in order to avoid the incident 1005 in lane 1011. Accordingly, FIGS. 10A-10D illustrate that the mitigative action selection techniques have the ability to orchestrate specifically timed and designated actions, between multiple connected vehicles, and across multiple lanes, in order to achieve even greater optimization for mitigating a disturbance. Therefore, the disclosed mitigative action selection techniques can realize a high level of adaptability, in a manner that is most optimal for the particular traffic scenario.

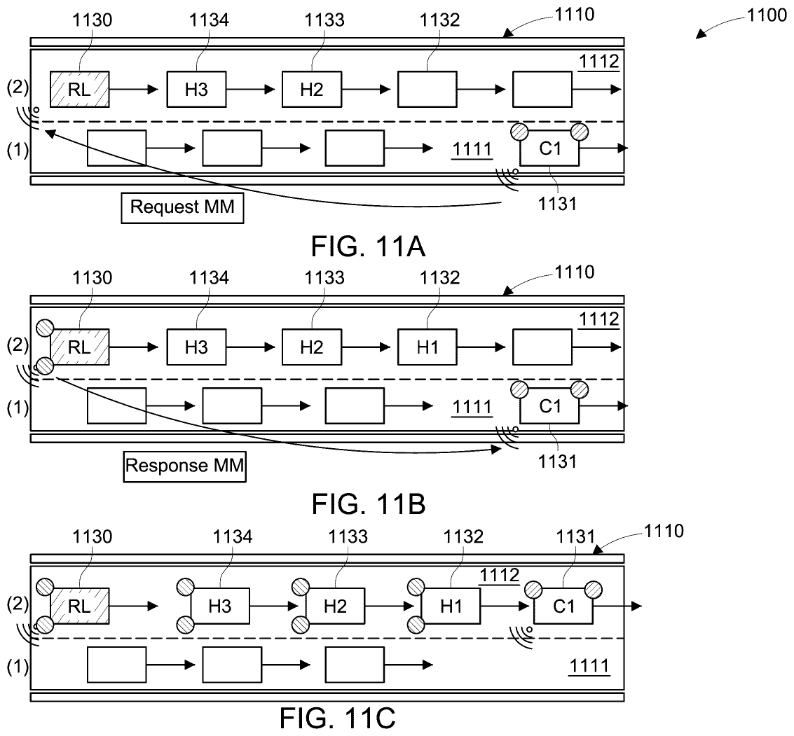

FIGS. 11A-11C depict another example environment 1100 to illustrate yet another operational example of how the mitigative action selection system (shown in FIG. 1) may function in a particular traffic scenario. A receiving vehicle 1130 can implement learning-based mitigative action selection functions (e.g., learning-based mitigative action selection is described in greater detail in FIGS. 4-6), in accordance with an embodiment. In the example environment 1100 of FIGS. 11A-11C, there is a two-lane highway 1110. FIGS. 11A-11C also illustrate that both lanes 1111, 1112 of the two-lane highway 1110 have similar densities. Also, in the example environment 1100, vehicle 1131 needs to perform a mandatory lane change from lane 1111 to the adjacent lane 1112. Considering the density of both lanes 1111, 1112, it can be determined that if vehicle 1131 performs the intended lane change from lane 1111 into lane 1112, then the action will cause a traffic disturbance wave to form and propagate downstream, disturbing the trailing vehicles that are traveling behind vehicle 1131 on the highway 1110. Thus, in order to mitigate this disturbance, vehicle 1131 requests for receiving vehicle 1130 to mitigate the disturbance based on its intended lane change. Prior to performing the intended lane change, FIG. 11A depicts that vehicle 1131 communicates a MM request to the vehicle 1130.

In this example, vehicle 1130 performs learning-based mitigative action selection techniques (rather than simulation-based mitigative action selection) and collects observations about the environment 1100, including: the distance to vehicle 1131; the density lanes 1111,1112; and a distance between vehicle 1131 to vehicle 1132, which is currently moving in the target lane 1112 near vehicle 1131. For example, during the learning-based mitigative action selection process, vehicle 1131 passes these observations to a neural network.

FIG. 11B illustrates vehicle 1131 returning an instruction (e.g., response MM) back to vehicle 1131, where the instruction is a mitigative action selected based on the learning-based mitigative action selection process executed by vehicle 1130. Furthermore, the learning-based mitigative action selection process also determines that vehicle 1130 should execute deceleration. Accordingly, for the next few seconds, the neural network (e.g., AI/ML agent) on vehicle 1130 will continue to instruct vehicle 1131 to slowly decelerate in order to create a buffer between itself and the wave of disturbance that will occur when vehicle 1131 changes lanes. FIG. 11C depicts a point in time after vehicle 1131 has completed its lane change maneuver into adjacent lane 1112, and where vehicle 1130 has slowed-down creating a substantive amount of space between itself and the immediately preceding vehicle 1134, as a result of the mitigative action selection techniques. This buffer (shown in FIG. 11C as an increased distance between vehicle 1130 and 1134 in lane 1112) provides safe distancing between vehicle 1130 and the other vehicles upstream on highway 1110 such that a disturbance (caused by the lane change of vehicle 1131) is sufficiently absorbed in a manner ensuring that vehicle 1130 does not have react abruptly (e.g., sudden braking) when vehicle 1131 enters lane 1112, which can cause several issues such as an accident, driver discomfort, or traffic congestion.

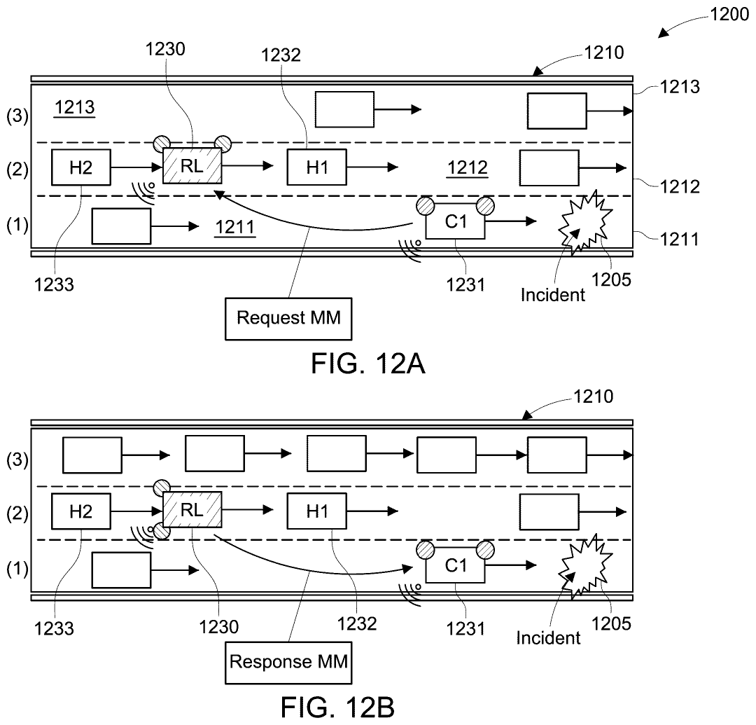

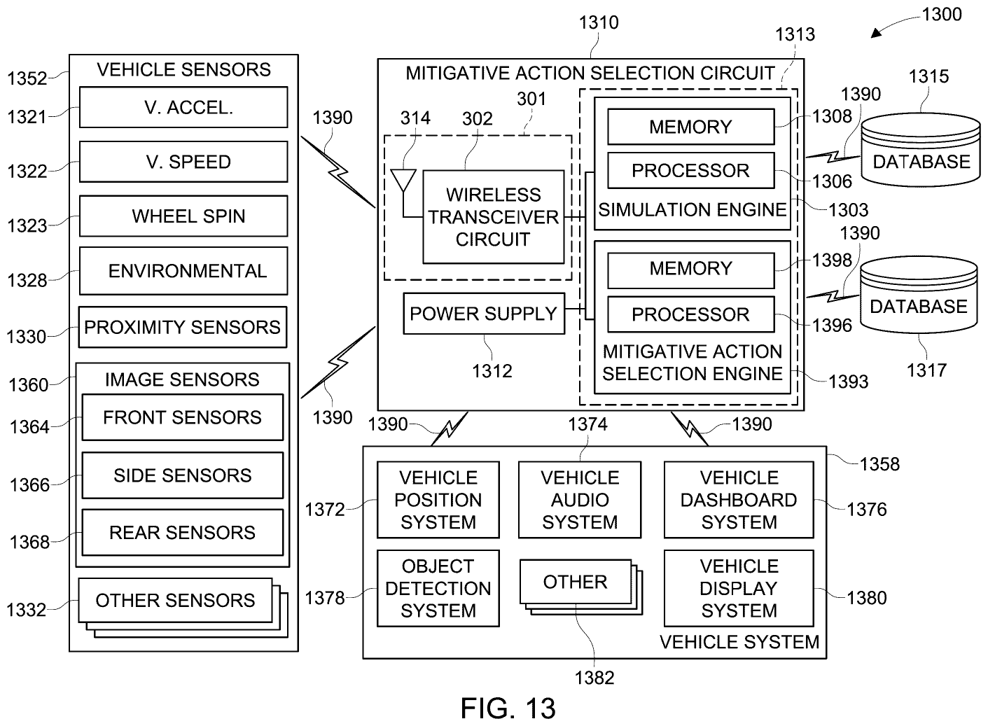

FIGS. 12A-12B depict another example environment 1200 to illustrate an yet another operational example of how the mitigative action selection system (shown in FIG. 1) may function in a particular traffic scenario. A receiving vehicle 1230 can implement the learning-based mitigative action selection techniques, as disclosed herein. Furthermore, in the example environment 1200 of FIGS. 12A-12B, there is an incident 1205 in lane 1211 on a three-lane highway 1210. Thus, in order to avoid the approaching incident 1205 in lane 1211, vehicle 1231 may desire to perform a lane change into adjacent lane 1212. Prior to performing the lane change, FIG. 12A illustrates that vehicle 1231 sends a MM request to vehicle 1230 for disturbance mitigation, where vehicle 1230 is currently traveling in the target lane 1212.

Rather than simulating the environment, the vehicle 1230 executes learning-based mitigative action selection techniques, as disclosed herein, and collects several observations about the environment 1200, including: distance between vehicle 1230 and vehicle 1231; the density of lanes 1211-1213; and distance between vehicle 1231 and vehicle 1232, which is currently traveling in the target lane 1212 nearby vehicle 1231. These observations can be input into the neural network (e.g., AI/ML agent) on vehicle 1230 in order to perform the learning-based mitigative action selection process. FIG. 12B illustrates that a mitigative action selected by vehicle 1230, as a result of the learning-based analysis, is sent as a MM response back to vehicle 1231. For example, the MM response can be an instruction for vehicle 1231 to perform a lane change maneuver into the adjacent lane 1213 having low density, rather than the initially proposed lane 1212. In this case, the neural network of vehicle 1230 may have learned over time that lane changing to a lower density lane is safer in this particular scenario. Consequently, as lane 1213 is observed to have a substantively lower density than lane 1212 in the environment 1200, then vehicle 1230 can determine that vehicle 1231 performing a lane change to lane 1213 is the optimal mitigative action for the particular scenario.

FIG. 13 illustrates an example of a mitigative action selection system 1300 in a vehicle in accordance with one embodiment of the systems and methods described herein. The mitigative action selection system 1300 includes a mitigative action selection circuit 1310 communicatively connected to a plurality of sensors 1352, a plurality of vehicle systems 1358, a database 1315 comprising roadway data, and a database 1317 comprising right-of-way rules. Sensors 1352 and vehicle systems 1358 wirelessly communicate with the mitigative action selection circuit 1310. Although in this example sensors 1352 and vehicle systems 1358 are depicted as communicating with mitigative action selection circuit 1310, they can also communicate with each other as well as with other vehicle systems. The mitigative action selection circuit 1310 can be implemented as an ECU or as part of an ECU. In other embodiments, the mitigative action selection circuit 1310 can be implemented independently of the ECU.

The mitigative action selection circuit 1310 in this example includes a communication circuit 1301, a controller/CPU 1313 comprising a simulation engine 1303, and a mitigative action selection engine 1393, and a power supply 1312. Each engine includes a respective processor 1306, 1396 and respective memory 1308, 1396. For example, the simulation engine 1303 includes a processor 1306, and a memory 1308 configured for performing the simulation (e.g., including lane density estimation) techniques described herein, and the mitigative action selection engine 1393 includes a processor 1396 and a memory 1398 configured for performing the mitigative action selection techniques described herein.

Processor 1306 can include one or more GPUs, CPUs, microprocessors, or any other suitable processing system. Processor 1306 may include a single core or multicore processors. The memory 1308 may include one or more various forms of memory or data storage (e.g., flash, RAM, etc.) that may be used to store instructions and variables for processor 1306 as well as any other suitable information, such as, one or more of the following elements: rules data; resource data; GPS data; and base data, as described below. Memory 1308 can be made up of one or more modules of one or more different types of memory, and may be configured to store data and other information as well as operational instructions that may be used by the processors 1306 and 1396.

Although the example of FIG. 13 is illustrated using processor and memory circuitry, as described below with reference to circuits disclosed herein, controller/CPU 1313 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up the mitigative action selection circuit 1310. Communication circuit 1301 includes either or both a wireless transceiver circuit 1302 with an associated antenna 1314 and a wired I/O interface with an associated hardwired data port (not illustrated). Communication circuit 1301 can provide for V2X communications capabilities, allowing the mitigative action selection circuit 1310 to communicate with edge devices, such as roadside equipment (RSE), network cloud servers and cloud-based databases, and/or other vehicles.

As this example illustrates, communications with the mitigative action selection circuit 1310 can include either or both wired and wireless communications circuits 1301. Wireless transceiver circuit 1302 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 1314 is coupled to wireless transceiver circuit 302 and is used by wireless transceiver circuit 1302 to transmit radio signals wirelessly to wireless equipment with which it is connected and to receive radio signals as well. These RF signals can include information of almost any sort that is sent or received by the mitigative action selection circuit 1310 to/from other entities such as sensors 1352 and vehicle systems 1358.

Power supply 1312 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

In the illustrated example, sensors 1352 include vehicle acceleration sensors 1321, vehicle speed sensors 1322, wheelspin sensors 1323 (e.g., one for each wheel), environmental sensors 1328 (e.g., to detect salinity or other environmental conditions), proximity sensor 1330 (e.g., sonar, radar, lidar or other vehicle proximity sensors), and image sensors 1360. Additional sensors (i.e., other sensors 1332) can be included as may be appropriate for a given implementation of mitigative action selection system 1300.

The sensors 1352 include front facing image sensors 1364, side facing image sensors 1366, and/or rear facing image sensors 1368. Image sensors may capture information which may be used in detecting not only vehicle conditions but also detecting conditions external to the ego vehicle 120 (shown in FIG. 1) as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 1360 can be used to, for example, to detect objects in an environment surrounding ego vehicle 120, for example, traffic signs indicating a current speed limit, road curvature, obstacles, surrounding vehicles, and so on. For example, one or more image sensors 1360 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 1360 may include cameras that may be used with and/or integrated with other proximity sensors 1330 such as LIDAR sensors or any other sensors capable of capturing a distance. As used herein, a sensor set of a vehicle may refer to sensors 1352 and image sensors 1360 as a set.

Vehicle systems 1358 include any of a number of different vehicle components or subsystems used to control or monitor various aspects of the vehicle and its performance. In this example, the vehicle systems 358 includes a vehicle positioning system 1372; vehicle audio system 1374 comprising one or more speakers configured to deliver audio throughout the vehicle; object detection system 1378 to perform image processing such as object recognition and detection on images from image sensors 1360, proximity estimation, for example, from image sensors 1360 and/or proximity sensors, etc. for use in other vehicle systems; suspension system 1380 such as, for example, an adjustable-height air suspension system, or an adjustable-damping suspension system; and other vehicle systems 1382 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 1372 includes a global positioning system (GPS). Ego vehicle 120 and the one or more connected vehicles 101A-101C (shown in FIG. 1) may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 1390 may be a conventional type of network, wired or wireless, and may have numerous different configurations including a star configuration, token ring configuration, or other configurations. Furthermore, the network 1390 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 1390 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, Wave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 1390 may include one or more IEEE 802.11 wireless networks.

In one embodiment, data comprising the location of vehicle is captured by the vehicle position system 1358. The vehicle position system 1358 can include one or more sensors 1352 configured to capture vehicle position data. The vehicle positioning system 1372 communicates with the mitigative action selection circuit 1310 to communicate and utilize mitigative actions at the ego vehicle 120 for various driving and/or maneuvering functions, including autonomous or semi-autonomous vehicle/driver safety features.

In an embodiment, the mitigative action selection system 1300 produces notifications for the driver of the ego vehicle 120 using one or more notification methods. For example, the driver may receive a visual and/or audible notification that the vehicle may need to perform a maneuver to avoid an approaching traffic incident and/or traffic congestion, based on data that the mitigative action selection circuit 1310 has analyzed accordance with the mitigative action selection capabilities, as disclosed herein. In one embodiment, the notification methods include the vehicle systems 1358 comprising the vehicle audio system 1372 and the vehicle dashboard system 1376. The notification methods includes visual and/or audible methods of informing the driver of safety related issues. In one embodiment, the notification methods include notifying the driver of the ego vehicle 120 via one or more vehicle systems 1358. For example, in one embodiment, the driver is notified of a selected mitigative maneuver via the vehicle audio system 1374 (e.g., instructions played/broadcasted over one or more vehicle speakers), the vehicle display system 1380 and/or the vehicle dashboard system 1376. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the mitigative action selection system 1300 to the driver).

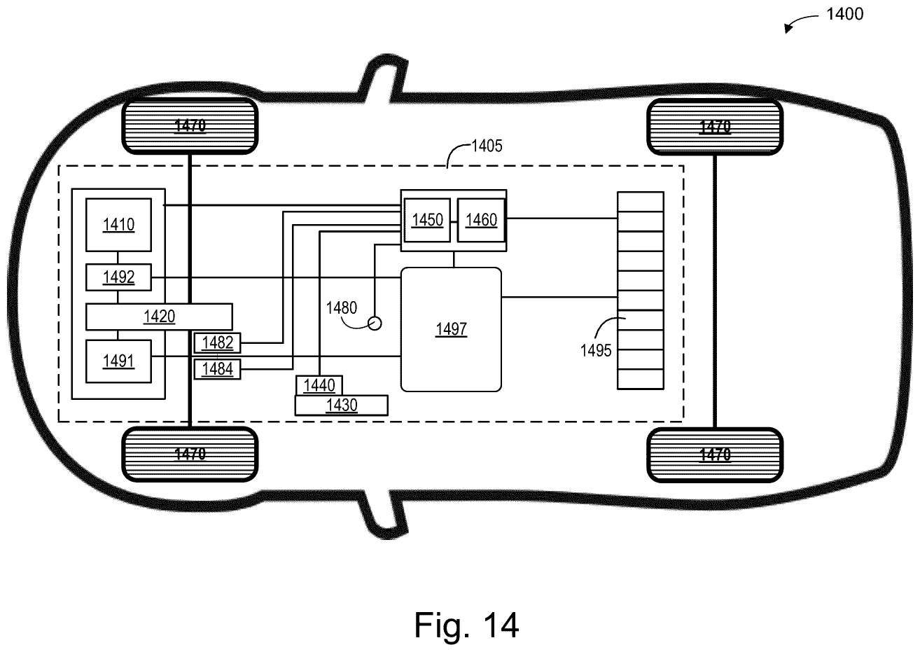

FIG. 14 illustrates an example hybrid electric vehicle (HEV) 1400 in which various embodiments for the mitigative action selection system are implemented. For example, in one embodiment, the ego vehicle 120 (shown in FIG. 1) is a HEV 1400. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 1400 includes drive force unit 1405 and wheels 1470. Drive force unit 1405 includes an engine 1410, motor generators (MGs) 1491 and 1492, a battery 1495, an inverter 1497, a brake pedal 1430, a brake pedal sensor 1440, a transmission 1420, a memory 1460, an electronic control unit (ECU) 1450, a shifter 1480, a speed sensor 1482, and an accelerometer 1484.

Engine 1410 primarily drives the wheels 1470. Engine 1410 can be an ICE that combusts fuel, such as gasoline, ethanol, diesel, biofuel, or other types of fuels which are suitable for combustion. The torque output by engine 1410 is received by the transmission 1420. MGs 1491 and 1492 can also output torque to the transmission 1420. Engine 1410 and MGs 1491 and 1492 may be coupled through a planetary gear (not shown in FIG. 4). The transmission 1420 delivers an applied torque to the wheels 1470. The torque output by engine 1410 does not directly translate into the applied torque to the wheels 1470.

MGs 1491 and 1492 can serve as motors which output torque in a drive mode, and can serve as generators to recharge the battery 1495 in a regeneration mode. The electric power delivered from or to MGs 1491 and 1492 passes through inverter 1497 to battery 1495. Brake pedal sensor 1440 can detect pressure applied to brake pedal 1430, which may further affect the applied torque to wheels 1470. Speed sensor 1482 is connected to an output shaft of transmission 1420 to detect a speed input which is converted into a vehicle speed by ECU 1450. Accelerometer 1484 is connected to the body of HEV 1400 to detect the actual deceleration of HEV 1400, which corresponds to a deceleration torque.

Transmission 1420 is a transmission suitable for an HEV. For example, transmission 1420 can be an electronically controlled continuously variable transmission (ECVT), which is coupled to engine 1410 as well as to MGs 1491 and 1492. Transmission 1420 can deliver torque output from a combination of engine 1410 and MGs 1491 and 1492. The ECU 1450 controls the transmission 1420, utilizing data stored in memory 1460 to determine the applied torque delivered to the wheels 1470. For example, ECU 1450 may determine that at a certain vehicle speed, engine 1410 should provide a fraction of the applied torque to the wheels while MG 491 provides most of the applied torque. ECU 1450 and transmission 1440 can control an engine speed (NE) of engine 1440 independently of the vehicle speed (V).

ECU 1440 may include circuitry to control the above aspects of vehicle operation. ECU 1440 may include, for example, a microcomputer that includes a one or more processing units (e.g., microprocessors), memory storage (e.g., RAM, ROM, etc.), and I/O devices. ECU 1440 may execute instructions stored in memory to control one or more electrical systems or subsystems in the vehicle. ECU 1440 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 1441 and 1442 each may be a permanent magnet type synchronous motor including for example, a rotor with a permanent magnet embedded therein. MGs 1441 and 1442 may each be driven by an inverter controlled by a control signal from ECU 1440 so as to convert direct current (DC) power from battery 1445 to alternating current (AC) power, and supply the AC power to MGs 1441, 1442. MG 1442 may be driven by electric power generated by motor generator MG 1441. It should be understood that in embodiments where MG 1441 and MG 1442 are DC motors, no inverter is required. The inverter, in conjunction with a converter assembly may also accept power from one or more of MGs 1441, 1442 (e.g., during engine charging), convert this power from AC back to DC, and use this power to charge battery 495 (hence the name, motor generator). ECU 1450 may control the inverter, adjust driving current supplied to MG 1492, and adjust the current received from MG 491 during regenerative coasting and braking.

Battery 1495 may be implemented as one or more batteries or other power storage devices including, for example, lead-acid batteries, lithium ion, and nickel batteries, capacitive storage devices, and so on. Battery 495 may also be charged by one or more of MGs 1491, 1492, such as, for example, by regenerative braking or by coasting during which one or more of MGs 1491, 1492 operates as generator. Alternatively (or additionally, battery 1495 can be charged by MG 1491, for example, when HEV 1400 is in idle (not moving/not in drive). Further still, battery 1495 may be charged by a battery charger (not shown) that receives energy from engine 1410. The battery charger may be switched or otherwise controlled to engage/disengage it with battery 1495. For example, an alternator or generator may be coupled directly or indirectly to a drive shaft of engine 1410 to generate an electrical current as a result of the operation of engine 1410. Still other embodiments contemplate the use of one or more additional motor generators to power the rear wheels of a vehicle (e.g., in vehicles equipped with 4-Wheel Drive), or using two rear motor generators, each powering a rear wheel.

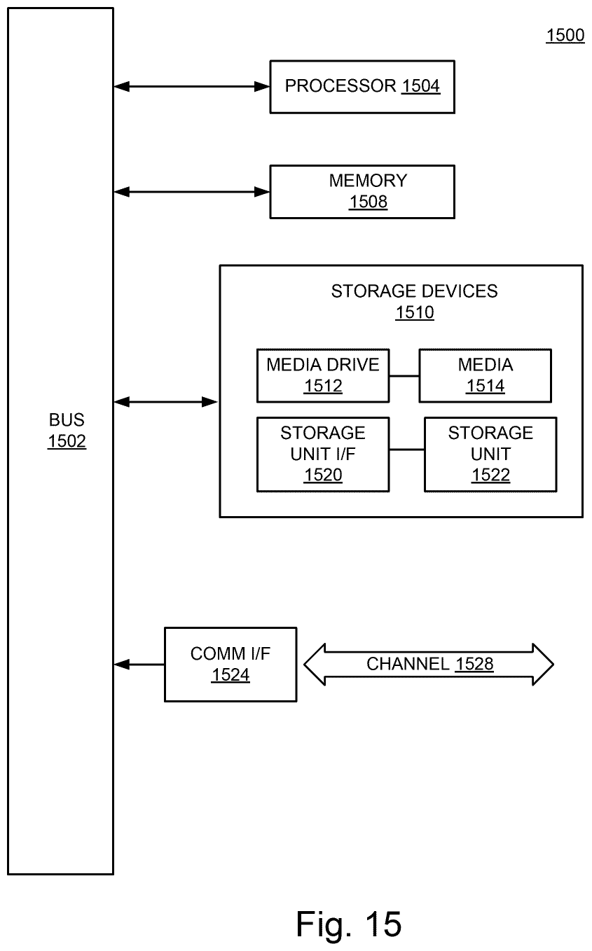

Battery 1495 may also be used to power other electrical or electronic systems in the vehicle. Battery 1495 can include, for example, one or more batteries, capacitive storage units, or other storage reservoirs suitable for storing electrical energy that can be used to power MG 1491 and/or MG 1492. When battery 1495 is implemented using one or more batteries, the batteries can include, for example, nickel metal hydride batteries, lithium ion batteries, lead acid batteries, nickel cadmium batteries, lithium ion polymer batteries, and other types of batteries.

Where components are implemented in whole or in part using software, these software elements can be implemented to operate with a computing or processing component capable of carrying out the functionality described with respect thereto. One such example computing component is shown in FIG. 15. Various embodiments are described in terms of this example-computing component 1500. After reading this description, it will become apparent to a person skilled in the relevant art how to implement the application using other computing components or architectures.

Referring now to FIG. 15, computing component 1500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1500 might also represent computing capabilities embedded within or otherwise available to a given device. For example, a computing component might be found in other electronic devices such as, for example, portable computing devices, and other electronic devices that might include some form of processing capability.

Computing component 1500 might include, for example, one or more processors, controllers, control components, or other processing devices. This can include a processor 1504. Processor 1504 might be implemented using a general-purpose or special-purpose processing engine such as, for example, a microprocessor, controller, or other control logic. Processor 1504 may be connected to a bus 502. However, any communication medium can be used to facilitate interaction with other components of computing component 1500 or to communicate externally.

Computing component 1500 might also include one or more memory components, simply referred to herein as main memory 1508. For example, random access memory (RAM) or other dynamic memory, might be used for storing information and instructions to be executed by processor 1504. Main memory 1508 might also be used for storing temporary variables or other intermediate information during execution of instructions to be executed by processor 1504. Computing component 1500 might likewise include a read only memory (“ROM”) or other static storage device coupled to bus 1502 for storing static information and instructions for processor 1504.

The computing component 1500 might also include one or more various forms of information storage mechanism 1510, which might include, for example, a media drive 1512 and a storage unit interface 1520. The media drive 1512 might include a drive or other mechanism to support fixed or removable storage media 1514. For example, a hard disk drive, a solid-state drive, a magnetic tape drive, an optical drive, a compact disc (CD) or digital video disc (DVD) drive (R or RW), or other removable or fixed media drive might be provided. Storage media 1514 might include, for example, a hard disk, an integrated circuit assembly, magnetic tape, cartridge, optical disk, a CD or DVD. Storage media 1514 may be any other fixed or removable medium that is read by, written to or accessed by media drive 1512. As these examples illustrate, the storage media 1514 can include a computer usable storage medium having stored therein computer software or data.

In alternative embodiments, information storage mechanism 1510 might include other similar instrumentalities for allowing computer programs or other instructions or data to be loaded into computing component 1500. Such instrumentalities might include, for example, a fixed or removable storage unit 1522 and an interface 1520. Examples of such storage units 1522 and interfaces 1520 can include a program cartridge and cartridge interface, a removable memory (for example, a flash memory or other removable memory component) and memory slot. Other examples may include a PCMCIA slot and card, and other fixed or removable storage units 1522 and interfaces 1520 that allow software and data to be transferred from storage unit 1522 to computing component 500.

Computing component 1500 might also include a communications interface 1524. Communications interface 1524 might be used to allow software and data to be transferred between computing component 1500 and external devices. Examples of communications interface 1524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1524 may be carried on signals, which can be electronic, electromagnetic (which includes optical) or other signals capable of being exchanged by a given communications interface 1524. These signals might be provided to communications interface 1524 via a channel 1528. Channel 1528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1508, storage unit 1520, media 1514, and channel 1528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a processor device analyzing data associated with a driving environment of a vehicle and selecting a mitigative action for the vehicle in response to a traffic disturbance present in the driving environment based on analyzing the data, wherein the data comprises messages communicated by a plurality of communicatively connected vehicles in the vicinity of the driving environment; and
a controller device executing autonomous actions to maneuver the vehicle based on the selected mitigative action.

2. The system of claim 1, wherein the system comprises a wireless communication device connected to the plurality of communicatively connected vehicles.

3. The system of claim 2, wherein the messages comprise one or more of: basic safety messages, maneuver messages, and sensor messages.

4. The system of claim 1, comprising vehicle sensors generating sensor data associated with the driving environment.

5. The system of claim 2, wherein the processor device generates lane density estimates for one or more lanes in a road of the driving environment.

6. The system of claim 6, wherein the processor device simulates effects of one or more mitigative actions on the driving environment based on lane density estimates.

7. The system of claim 6, wherein the processor device simulates the effects of one or more mitigative actions by evaluating a cost function associated with an attenuation of the traffic disturbance for the one or more lanes in a road of the driving environment

8. The system of claim 7, wherein the processor device selects the mitigative action and a corresponding lane for the mitigative action that are associated with a lowest attenuation of the traffic disturbance based on the cost function.

9. The system of claim 8, wherein the processor device generates messages for communicating to the plurality of communicatively connected vehicles based on the selected mitigative action, and generates control commands to effectuate the autonomous actions to maneuver the vehicle based on the selected mitigative action.

10. The system of claim 9, wherein the processor device generates intent messages associated with the selected mitigative action for communicating to the plurality of communicatively connected vehicles.

11. The system of claim 10, wherein the processor device selects additional mitigative actions for one or more of the plurality of communicatively connected vehicles to perform a cooperative maneuver that further attenuates the traffic disturbance.

12. The system of claim 11, wherein the processor device generates maneuver request messages for communicating the selected additional mitigative actions of the cooperative maneuver to the one or more of the plurality of communicatively connected vehicles.

13. The system of claim 12, wherein the maneuver request messages effectuate autonomous actions to maneuver the one or more of the plurality of communicatively connected vehicles in coordination with the selected mitigative actions to perform the cooperative maneuver.

14. The system of claim 2, wherein the processor device applies the data associated with a driving environment to an artificial intelligence (AI)/machine learning (ML) agent that is trained to select the mitigative action for the vehicle.

15. A non-transitory computer readable medium comprising instructions, that when read by a processor, cause the processor to perform:
analyzing data associated with a driving environment of a vehicle, wherein the data comprises messages communicated by a plurality of communicatively connected vehicles in the vicinity of the driving environment;
selecting a mitigative action for the vehicle in response to a traffic disturbance included in the driving environment based on analyzing the data; and
executing autonomous actions to maneuver the vehicle based on the selected mitigative action.

16. The non-transitory computer readable medium of claim 15, wherein the data associated with the driving environment is received from a plurality of communicatively connected vehicles via a wireless network.

17. The non-transitory computer readable medium of claim 16, comprising instructions that further cause the processor to perform:
generating lane density estimates for one or more lanes in a road of the driving environment; and
generating traffic simulations including the effects of one or more mitigative actions on the driving environment based on lane density estimates.

18. The non-transitory computer readable medium of claim 17, comprising instructions that further cause the processor to perform:
evaluating a cost function associated with an attenuation of the traffic disturbance for the one or more lanes in a road of the driving environment.

19. The non-transitory computer readable medium of claim 18, comprising instructions that further cause the processor to perform:
selecting the mitigative action and a corresponding lane for the mitigative action that are associated with a lowest attenuation of the traffic disturbance based on the cost function.

20. The non-transitory computer readable medium of claim 19, comprising instructions that further cause the processor to perform:
selecting additional mitigative actions for one or more of the plurality of communicatively connected vehicles to perform a cooperative maneuver that lowers the attenuation the traffic disturbance.
